(19) United States
(12) Patent Application Publication
(10) Pub. No.: US 2013/0098407 A1
(43) Pub. Date: Apr. 25, 2013

(54) INSTRUMENT REPROCESSORS, SYSTEMS, AND METHODS

(71) Applicants: Timothy J. Perlman, Pleasanton, CA (US); Sungwook Yang, Tustin, CA (US); Robert P. Michaloski, Laguna Niguel, CA (US)

(72) Inventors: Timothy J. Perlman, Pleasanton, CA (US); Sungwook Yang, Tustin, CA (US); Robert P. Michaloski, Laguna Niguel, CA (US)

(21) Appl. No.: 13/278,837

(22) Filed: Oct. 21, 2011

(51) Int. Cl. B08B 3/02; B08B 3/08; A47B 96/20

(52) U.S. Cl. 134/36; 49/260; 134/200; 134/34

(57) ABSTRACT

An instrument reprocessor is disclosed. The instrument reprocessor includes a basin having a rim located in an inclined plane forming an acute angle with respect to a horizontal plane. At least one nozzle is disposed in a plane substantially parallel to the inclined plane. The at least one nozzle is configured to discharge a stream into the basin in a direction substantially parallel to the inclined plane. A lid assembly is also disclosed. The lid assembly may cover the basin in a close configuration.

### TECHNICAL FIELD

This disclosure generally relates to the reprocessing, cleaning, sterilization, disinfection, and/or decontamination of medical instruments.

### BACKGROUND

In various circumstances, an endoscope can include an elongate portion, or tube, having a distal end which can be configured to be inserted into the body of a patient and, in addition, a plurality of channels extending through the elongate portion which can be configured to direct water, air, and/or any other suitable fluid into a surgical site. In some circumstances, one or more channels in an endoscope can be configured to guide a surgical instrument into the surgical site. In any event, an endoscope can further include a proximal end having inlets in fluid communication with the channels and, in addition, a control head section having one or more valves, and/or switches, configured to control the flow of fluid through the channels. In at least one circumstance, an endoscope can include an air channel, a water channel, and one or more valves within the control head configured to control the flow of air and water through the channels.

Decontamination systems can be used to reprocess previously-used medical devices, such as endoscopes, for example, such that the medical devices can be used again. A variety of decontamination systems exist for reprocessing endoscopes. In general, such systems may include at least one rinsing basin in which an endoscope that is to be cleaned and/or disinfected can be placed. The rinsing basin is commonly supported by a housing that supports a circulation system of lines, pumps and valves for the purpose of directing a cleaning and/or disinfecting agent into and/or onto an endoscope which has been placed in the basin. During the decontamination process, the channels within the endoscope can be evaluated in order to verify that the channels are unobstructed. In various embodiments, the circulation system can be fluidly coupled to the endoscope channels by connectors which releasably engage ports which can define the ends of the channels. Such connectors can achieve a fluid-tight seal while attached to the endoscope, yet they can be easily releasable at the conclusion of the decontamination process.

The foregoing discussion should not be taken as a disavowal of claim scope.

### SUMMARY

Various embodiments disclosed and described in this specification are directed, in part, to a lid assembly. The lid assembly comprises a frame comprising an opening, wherein the frame includes a frame hinge at a first end, and wherein the frame includes a guide along a first side. The lid assembly also comprises a lid that covers the opening in a closed configuration. The lid comprises a first lid panel having first and second ends, wherein the first lid panel is coupled at its first end to the frame hinge, and wherein the first lid panel is pivotable relative to the frame about the frame hinge. The lid also comprises a second lid panel having first and second ends, wherein the first lid panel and the second lid panel lie in a plane when the lid is in the closed configuration. The lid also comprises a lid hinge, wherein the first lid panel is coupled to the lid hinge at its second end, wherein the second lid panel is coupled to the lid hinge at its first end, and wherein the first lid panel is pivotable relative to the second lid panel about the lid hinge. The lid also comprises a lid hinge follower coupled to the second lid panel proximate to the second end, wherein the follower is movably engaged with the guide such that the follower follows the guide as the lid moves from the closed configuration to an open configuration. The lid assembly also comprises a displacer coupled to the frame at a location proximate to the lid hinge when the lid is in the closed configuration, wherein the displacer displaces the lid hinge away from the frame.

Various embodiments disclosed and described in this specification are directed, in part, to instrument reprocessors comprising a basin. The basin may comprise a bottom surface, a rim, and a sidewall connecting the bottom surface and the rim. The rim of the basin may be located in an inclined plane forming an acute angle with respect to the horizontal plane. At least one lateral nozzle may be located on the sidewall of the basin and disposed in a plane substantially parallel to the inclined plane. The lateral nozzle may be configured to discharge a stream into the basin in a direction substantially parallel to the inclined plane.

Various embodiments disclosed and described in this specification are directed, in part, to a method for reprocessing an instrument. The method comprises positioning an instrument in a basin in an instrument reprocessor. The basin comprises a rim located in an inclined plane forming an acute angle with respect to a horizontal plane, and the instrument is positioned in the basin, optionally contained in a carrier, in a plane substantially parallel to the inclined plane and at an acute angle with respect to the horizontal plane. The basin is covered, thereby forming a closed basin chamber. At least one lateral stream is discharged into the basin in a direction substantially parallel to the inclined plane. The at least one lateral stream is impinged onto an outer surface of the instrument to clean and/or disinfect the outer surface of the instrument. The instrument is not submerged in liquid in the basin chamber and, in some embodiments, there are substantially no horizontal surfaces in the basin that can collect liquid.

It is understood that the invention disclosed and described in this specification is not limited to the embodiments summarized in this Summary.

### BRIEF DESCRIPTION OF THE DRAWINGS

Various features and characteristics of the non-limiting and non-exhaustive embodiments disclosed and described in this specification may be better understood by reference to the accompanying figures as follows.

FIG. 1 illustrates an embodiment of an instrument reprocessor.

FIG. 2 illustrates a front view of the instrument reprocessor of FIG. 1.

FIG. 3 illustrates a rear view of the instrument reprocessor of FIG. 1.

FIG. 4 illustrates a right side view of the instrument reprocessor of FIG. 1.

FIG. 5 illustrates a top view of the instrument reprocessor of FIG. 1.

FIG. 6 illustrates a bottom view of the instrument reprocessor of FIG. 1.

FIG. 7 illustrates basins of the instrument reprocessor of FIG. 1.

FIG. 8 illustrates a view of the basins of FIG. 7 along plane A-A as shown in FIG. 4.

FIG. 9 illustrates a right sectional view of a basin of FIG. 7 along plane B-B.

FIG. 10 illustrates a left sectional view of a basin of FIG. 7 along plane C-C.

FIG. 11 illustrates an embodiment of a load carrier positionable within one of the basins of the endoscope reprocessor of FIG. 1.

FIG. 12 illustrates a top view of the load carrier of FIG. 11.

FIG. 13 illustrates a bottom view of the load carrier of FIG. 11.

FIG. 14 illustrates a left side view of the load carrier of FIG. 11.

FIG. 15 illustrates a front view of the load carrier of FIG. 11.

FIG. 16 illustrates a rear view of the load carrier of FIG. 11.

FIG. 17 is a front-right perspective view of an embodiment including an instrument reprocessing basin and a bi-fold lid in a closed configuration;

FIG. 18 is a rear-right perspective view of the basin and the bi-fold lid of FIG. 17;

FIG. 19 is a right-side view of the basin and the bi-fold lid of FIG. 17;

FIG. 20 is a left-side view of the basin and the bi-fold lid of FIG. 17;

FIG. 21 is a top-front view of the basin and the bi-fold lid of FIG. 17;

FIG. 22 is a bottom-rear view of the basin and the bi-fold lid of FIG. 17;

FIG. 23 is a front-right perspective view of the bi-fold lid of FIG. 17 in a partially open configuration;

FIG. 24 is a rear-right perspective view of the basin and the bi-fold lid of FIG. 17 illustrated in the configuration depicted in FIG. 23;

FIG. 25 is a right-side view of the basin and the bi-fold lid of FIG. 17 illustrated in the configuration depicted in FIG. 23;

FIG. 26 is a top-front view of the basin and the bi-fold lid of FIG. 17 illustrated in the configuration depicted in FIG. 23;

FIG. 27 is a front-right perspective view of the bi-fold lid of FIG. 17 in a fully open configuration;

FIG. 28 is a rear-right perspective view of the bi-fold lid of FIG. 17 illustrated in the configuration depicted in FIG. 27;

FIG. 29 is a right-side view of the bi-fold lid of FIG. 17 illustrated in the configuration depicted in FIG. 27;

FIG. 30 is a top-front view of the bi-fold lid of FIG. 17 illustrated in the configuration depicted in FIG. 27;

FIG. 31 is a right side view of the basin and the bi-fold lid of FIG. 17 illustrating a cam engaged with the bi-fold lid and holding the lid in a locked position;

FIG. 32 is a partial right side view of the basin and the bi-fold lid of Figure A illustrating the cam in an unlocked position; and

FIG. 33 is a partial right side view of the basin and the bi-fold lid of Figure A wherein the cam has displaced a portion of the bi-fold lid upwardly.

FIG. 33a is a right side view of a cam.

FIG. 34 is a schematic diagram illustrating the relative orientation of various nozzles with respect to an inclined plane.

FIG. 35 is a schematic diagram illustrating the relative orientation of various nozzles with respect to an inclined plane.

FIG. 36 is a schematic diagram illustrating the initial trajectory vector and the downstream trajectory of a stream discharged from a nozzle.

FIG. 37 is a schematic diagram illustrating the relative orientation of two nozzles with respect to two parallel inclined planes.

FIG. 38 is a schematic diagram illustrating the relative orientation of two nozzles with respect to two non-parallel inclined planes.

FIG. 39 is a right-side cross-sectional view of an inclined basin and nozzle assembly of an instrument reprocessor.

FIG. 40 is a right-perspective cross-sectional view of the inclined basin and nozzle assembly shown in FIG. 39.

FIG. 41 is an inclined view of two inclined basin and nozzle assemblies comprising a side-by-side dual-basin configuration, wherein the inclined basin and nozzle assemblies are as shown in FIGS. 39 and 40, and wherein the view is from a perspective that is perpendicular to an inclined plane containing the inclined rim portions of the basins.

FIG. 42 is a partial front-side view of the side-by-side dual-basin configuration shown in FIG. 41, wherein the inclined basin and nozzle assemblies are as shown in FIGS. 39 through 41.

FIG. 43 is a top-side view of the side-by-side dual-basin configuration shown in FIGS. 41 and 42, wherein the inclined basin and nozzle assemblies are as shown in FIGS. 39 through 42.

FIG. 44 is a right-side cross-sectional view of the inclined basin and nozzle assembly shown in FIGS. 39 through 43, wherein the basin contains an instrument carrier positioned in the basin and disposed in a plane that is substantially parallel to the inclined plane containing the inclined rim portion of the basin.

FIG. 45 is a right-perspective view of the basin, nozzle, and carrier assembly shown in FIG. 44.

FIG. 46 is an inclined view of the basin, nozzle, and carrier assembly shown in FIGS. 44 and 45, wherein the view is from a perspective that is perpendicular to an inclined plane containing the inclined rim portion of the basin.

FIG. 47 is a right-side view of the basin, nozzle, and carrier assembly shown in FIGS. 44 through 46.

FIG. 48 illustrates an endoscope positioned within a carrier in a basin.

This specification in conjunction with the accompanying drawings illustrates various non-limiting and non-exhaustive embodiments of the invention, which are not to be construed as limiting the scope of the invention in any manner.

### DETAILED DESCRIPTION

Before explaining various embodiments in detail, it should be noted that such embodiments are not limited in their application or use to the details of construction and arrangement of parts illustrated in the accompanying drawings and description. The illustrative embodiments may be implemented or incorporated in other embodiments, variations and modifications, and may be practiced or carried out in various ways. For example, the instrument reprocessors disclosed below are illustrative only and are not meant to limit the scope or application thereof. Furthermore, unless otherwise indicated, the terms and expressions employed herein have been chosen for the purpose of describing the illustrative embodiments for the convenience of the reader and are not intended to limit the scope thereof.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment”, or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation. Such modifications and variations are intended to be included within the scope of the present invention.

Various exemplary embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments and that the scope of the various embodiments is defined solely by the claims. The features illustrated or described in connection with one exemplary embodiment may be combined with the features of other embodiments. Such modifications and variations are intended to be included within the scope of the description and claims.

It will be appreciated that, for convenience and clarity, spatial terms such as “upper”, “lower”, “upwards”, “downwards”, “inwards”, “outwards”, “proximate”, “distant”, “horizontal”, “vertical”, and the like, are used herein with respect to an operator facing an instrument reprocessor or a component of an instrument reprocessor. These terms are not intended to be limited or absolute. Rather, they merely propose to explain a particular embodiment from a particular perspective.

As used herein, the term instrument reprocessor refers to an apparatus or system configured to wash, clean, decontaminate, disinfect, and/or sterilize an instrument such as, for example, an endoscope. As such, an instrument reprocessor may comprise washing functionality, cleaning functionality, decontaminating functionality, disinfecting functionality, sterilizing functionality, or combinations of any of these functionalities. Non-limiting examples of instrument reprocessors are described in United States Patent Application Publications Nos. 2004/0118413; 2007/0154346; and 2007/0154371; and in U.S. Pat. No. 7,879,289; which are incorporated by reference into this specification.

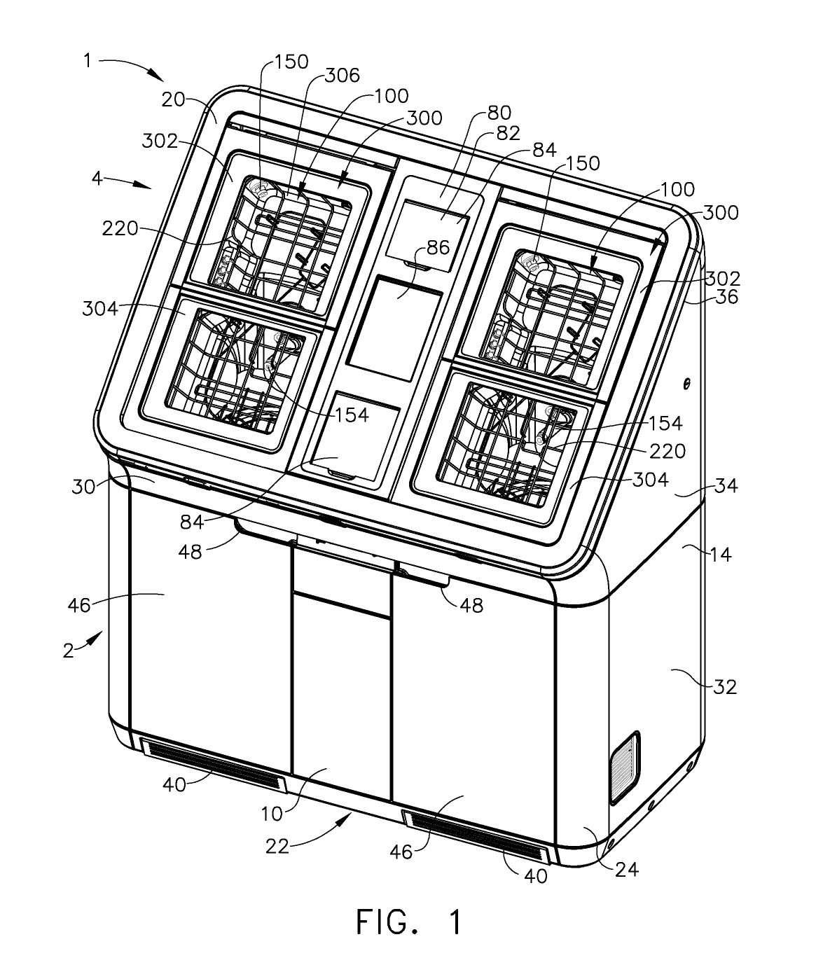

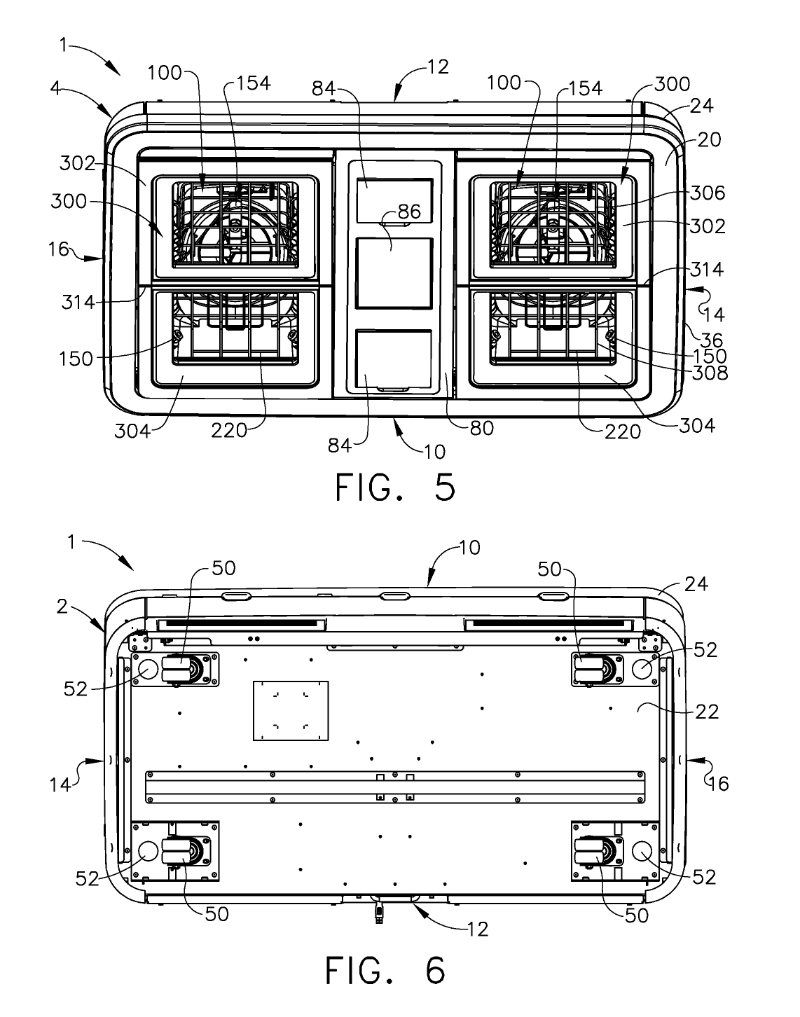

FIGS. 1-6 show an instrument reprocessor 1 according to at least one embodiment of the present invention. The instrument reprocessor 1 has a bottom pedestal 2 and a top portion 4. Further, the instrument reprocessor 1 has a front side 10, back side 12, right side 14, and left side 16 extending from a substantially rectangular base 22. The sides 10, 12, 14, 16 may be connected by corner sides 24, which may comprise rounded corners, for example, as illustrated in an embodiment of FIG. 1. Alternatively, corner sides 24 may have substantially square corners, for example. Though the instrument reprocessor 1 shown in FIGS. 1-6 has a substantially rectangular base 22, the invention is not limited to this embodiment and base 22 may be any suitable shape, such as a polygonal or rounded shape, for example.

In at least one embodiment, the instrument reprocessor 1 further comprises an angled side 20. Referring to FIGS. 1-6, front side 10, back side 12, right side 14 and left side 16 may extend upwards from base 22 to angled side 20. Base 22 may be substantially horizontal; front side 10, back side 12, right side 14 and left side 16 may be substantially vertical. Angled side 20 may be angularly positioned relative to base 22 and sides 10, 12, 14, 16. In at least one embodiment, the angled side 20 may be angled upwardly at an approximately 45 degree angle, for example. In certain embodiments, the angled side 20 may be angled upwardly at an approximately 30 degree angle, for example. In various embodiments, the angled side 20 may be angled upwardly at an approximately 70 degree angle, for example. In certain embodiments, the angled side 20 may be angled upwardly at any suitable angle between approximately thirty degrees and approximately seventy-five degrees from base 22, for example.

In at least one embodiment, the front side 10 extends upwardly from the base 22 to approximately one meter in height, for example. In another embodiment, front side 10 contacts angled side 20 at approximately the operator's waist height. Angled side 20 may extend wider or narrower than base 22. A connecting panel 30 may connect front side 10 and angled side 20. Connecting panel 30 may be horizontal, vertical, angled, straight and/or curved to connect front side 10 of pedestal 2 to angled side 20 of top portion 4.

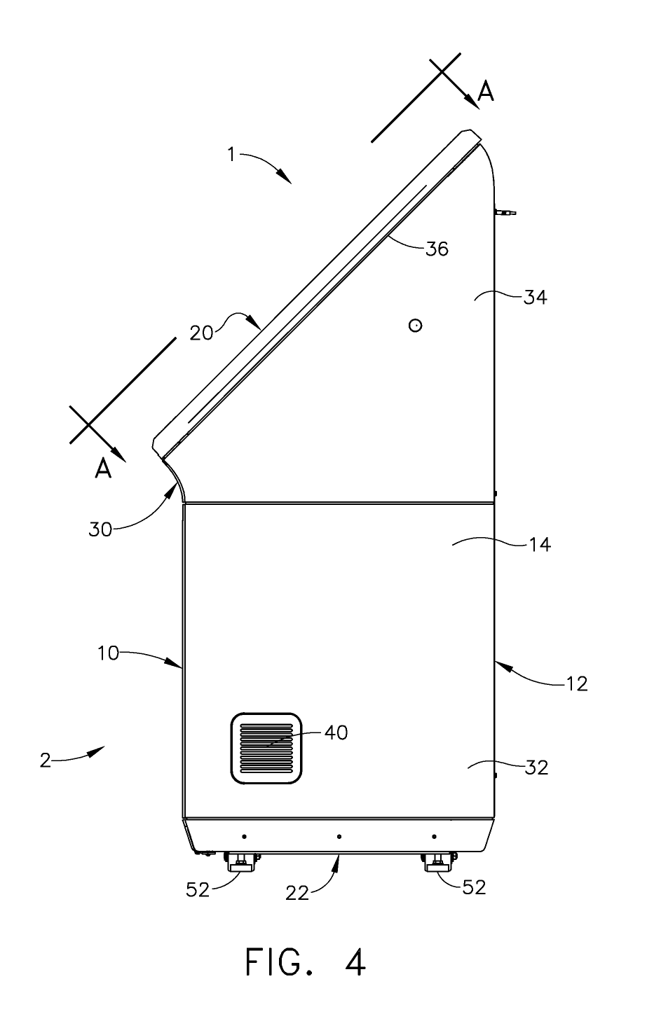

With reference to FIGS. 1 and 4, right side 14 has a bottom side panel 32 and a top side panel 34. Top side panel 34 includes an angled top edge 36. In a least one embodiment, angled top edge 36 is parallel to angled side 20. In various embodiments, referring to FIG. 1, right side 14 is a mirror image of or symmetrical with respect to, the left side 16. Accordingly, left side 16 of the instrument reprocessor 1 may have a bottom side panel 32 and a top side panel 34 that includes an angled top edge 36, which are mirror image reflections of the panels 32, 34 and top edge 36 of right side 14.

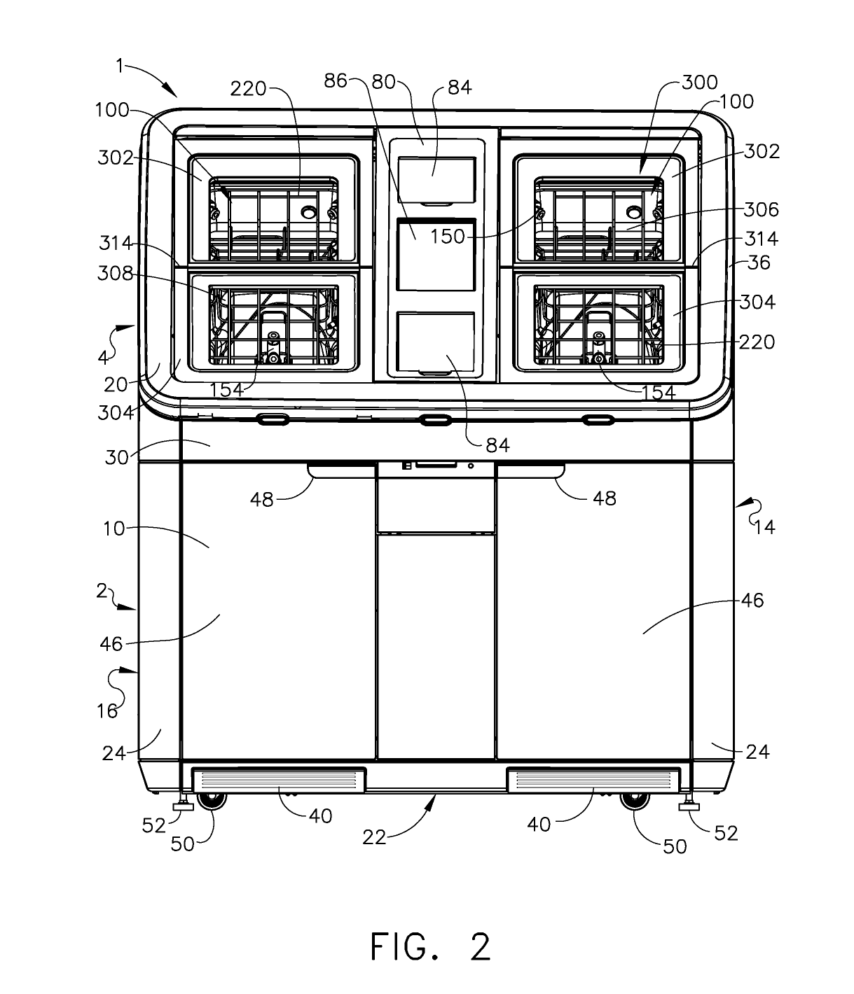

In various embodiments, the overall dimensions of the instrument reprocessor 1 may allow the instrument reprocessor 1 to move through doorways and hallways. The instrument reprocessor 1 may also comprise casters 50 and/or feet 52. Referring to FIGS. 2-6, base 10 may be supported by casters 50. In an embodiment shown in FIGS. 2-6, the instrument reprocessor 1 has four casters 50. Casters 50 may be lockable. In an unlocked position, casters 50 may facilitate movement of the instrument reprocessor 1; in a locked position, casters 50 may restrain movement of the instrument reprocessor 1. Further, the instrument reprocessor 1 may have feet 52 extending from base 22. In an embodiment shown in FIGS. 2-6, the instrument reprocessor 1 has four feet 52. Feet 52 may be lifted to facilitate movement of the instrument reprocessor 1. Upon reaching a resting location, feet 52 may be lowered to support the instrument reprocessor 1 in a stationary position. Casters 50 and feet 52 shown in FIGS. 2-6 illustrate a non-limiting embodiment of the invention; the instrument reprocessor 1 may comprise fewer or more castors 50 and/or feet 52 in any suitable combination and arrangement to support the instrument reprocessor 1. Alternatively, base 22 of the instrument reprocessor 1 may not have any casters and/or legs wherein base 22 may sit directly on the floor, for example.

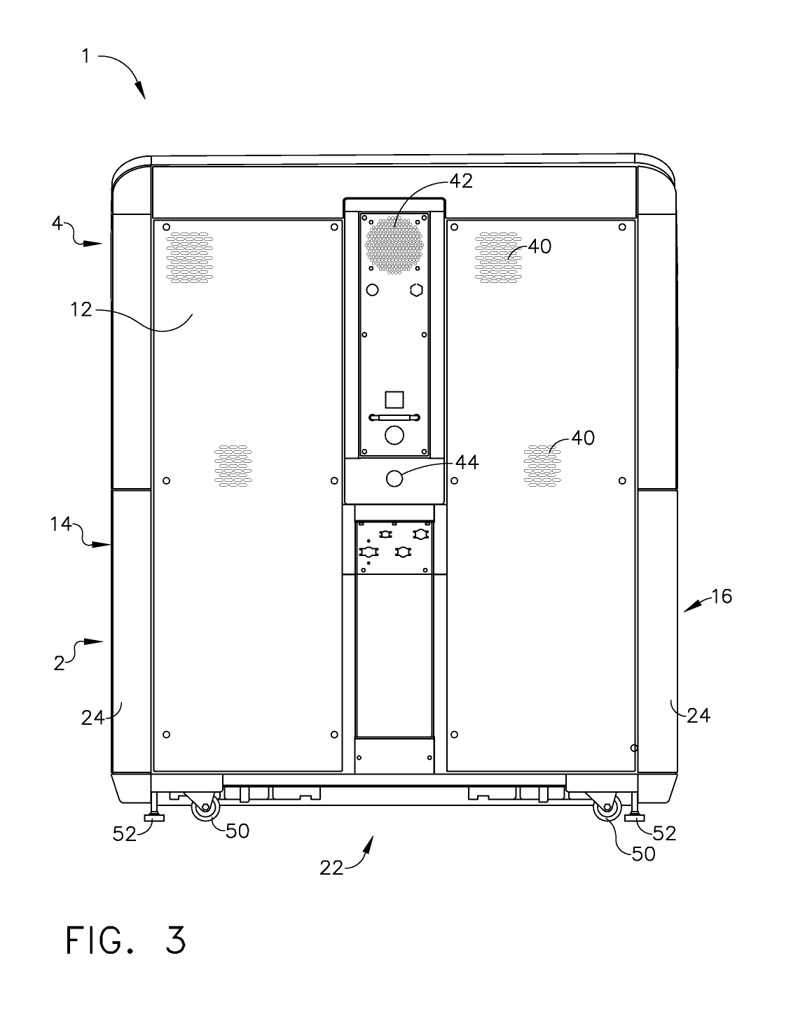

In various embodiments, referring to FIGS. 1 and 2, front side 10 of bottom pedestal 2 has two doors 46, for example. Doors 46 may provide the operator with a means to access the interior of bottom pedestal 2. Alternatively, the instrument reprocessor 1 could have one door 46 or multiple doors 46 and the doors 46 could be located on the front side 10, back side 12, right side 14, left side 16, angled side 20, and/or base 22. Door 46 may have a handle 48 for ease of opening door 46. Further, the instrument reprocessor 1 may comprise multiple vents 40 and/or fans 42. Referring to FIGS. 1 and 2, the front side 10 may comprise multiple vents 40. Referring to FIG. 3, back side 12 may comprise multiple vents 40. The vent arrangements in FIGS. 1-3 are merely illustrative and are not intended to limit the scope of the invention. Additional illustrative vent arrangements are shown in FIG. 4 (the right side 14 of the instrument reprocessor 1). Vents 40 may also be located on angled side 20. Instrument reprocessor 1 may also comprise a cooling fan 42. Referring to FIG. 3, a cooling fan 42 may be located on the back side 12 of the instrument reprocessor 1. Alternatively or additionally, a cooling fan 42 may be located on front side 2, right side 6, left side 8, angled side 20, and/or base 22 of the instrument reprocessor 1.

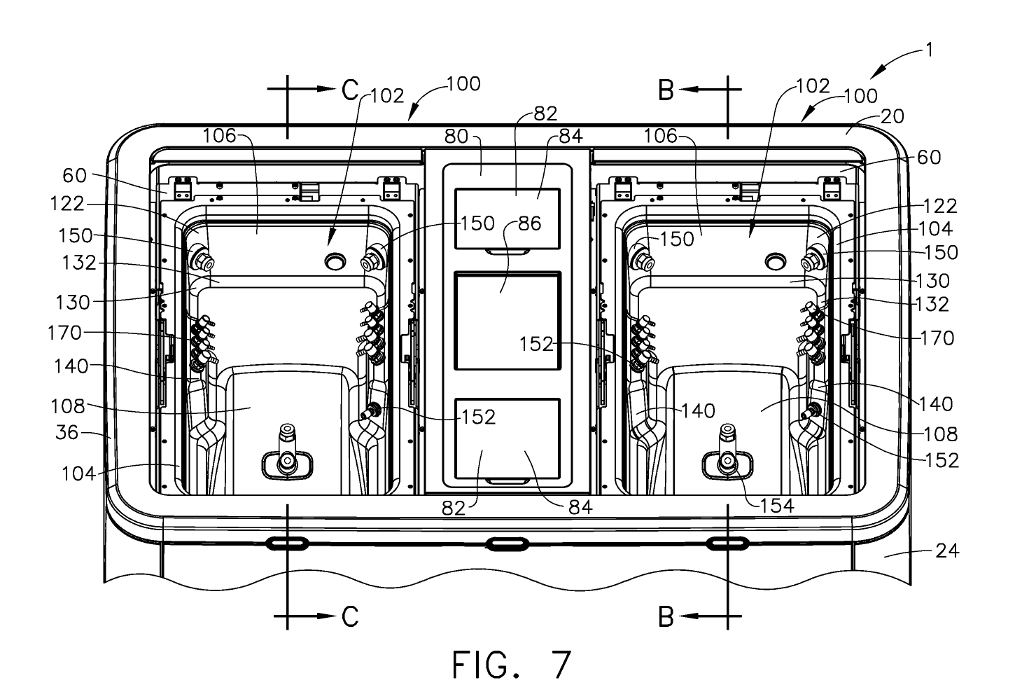

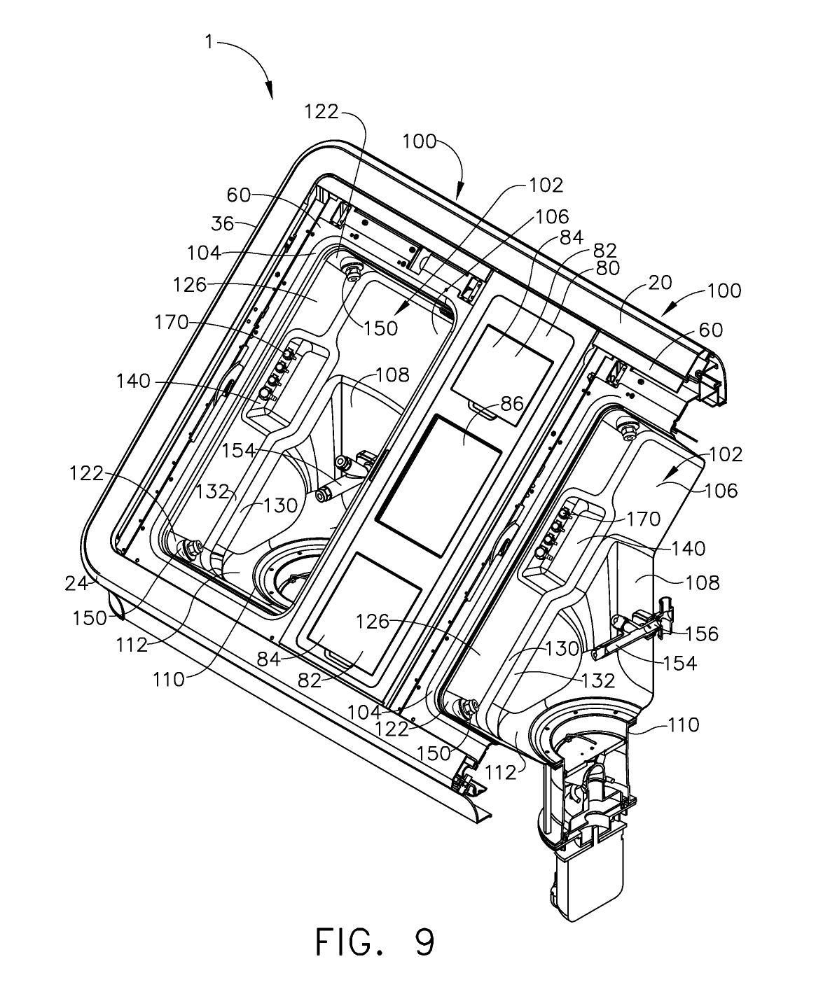

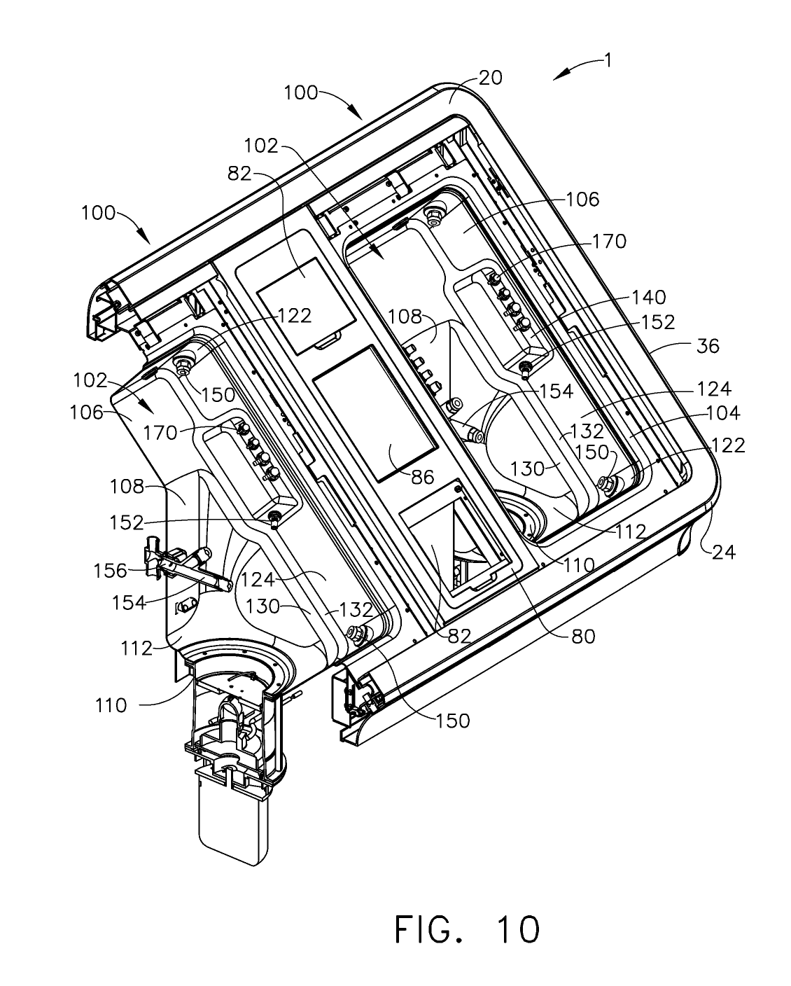

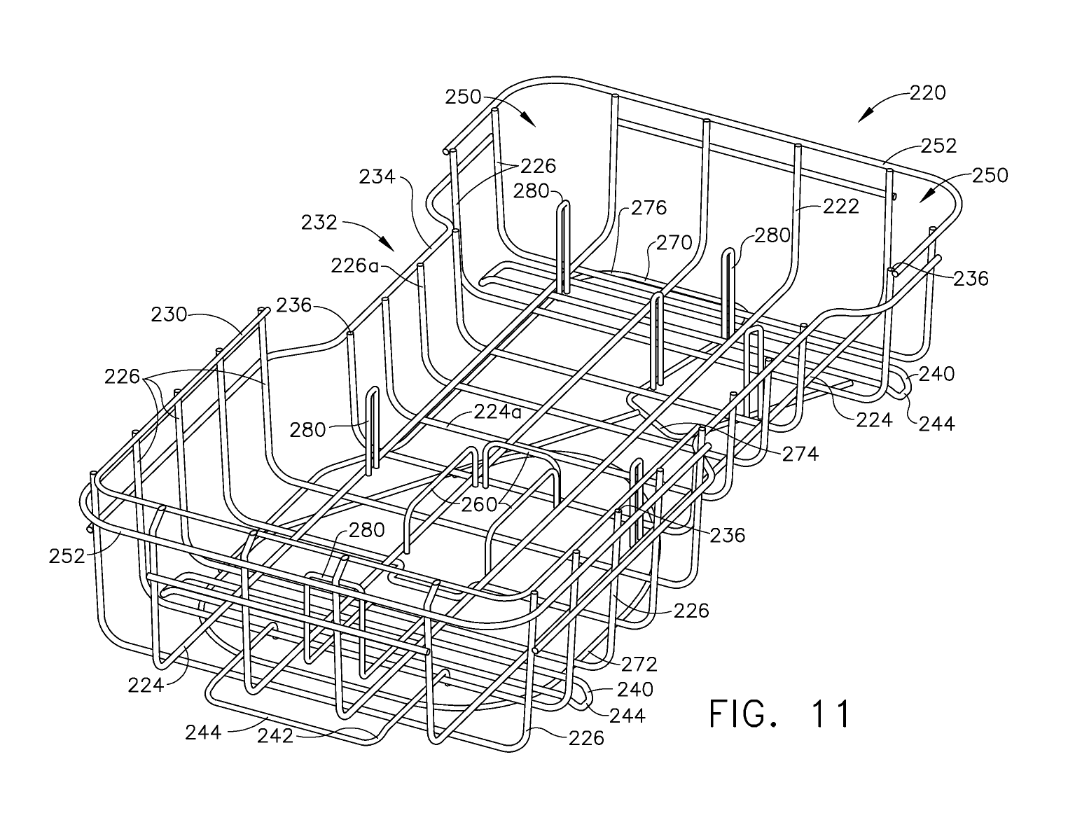

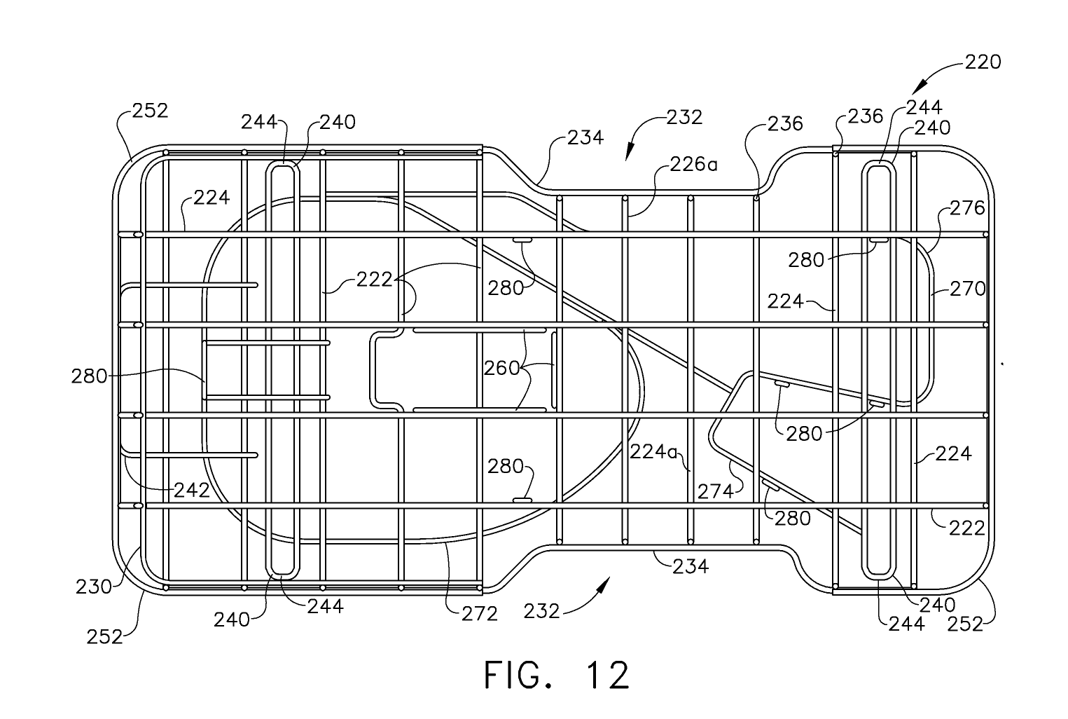

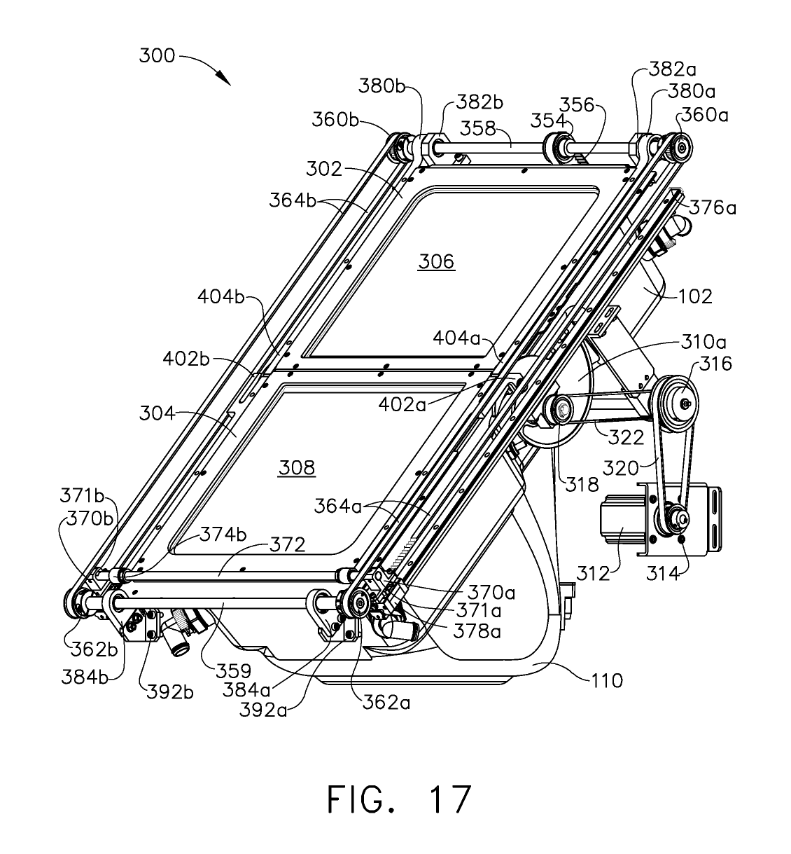

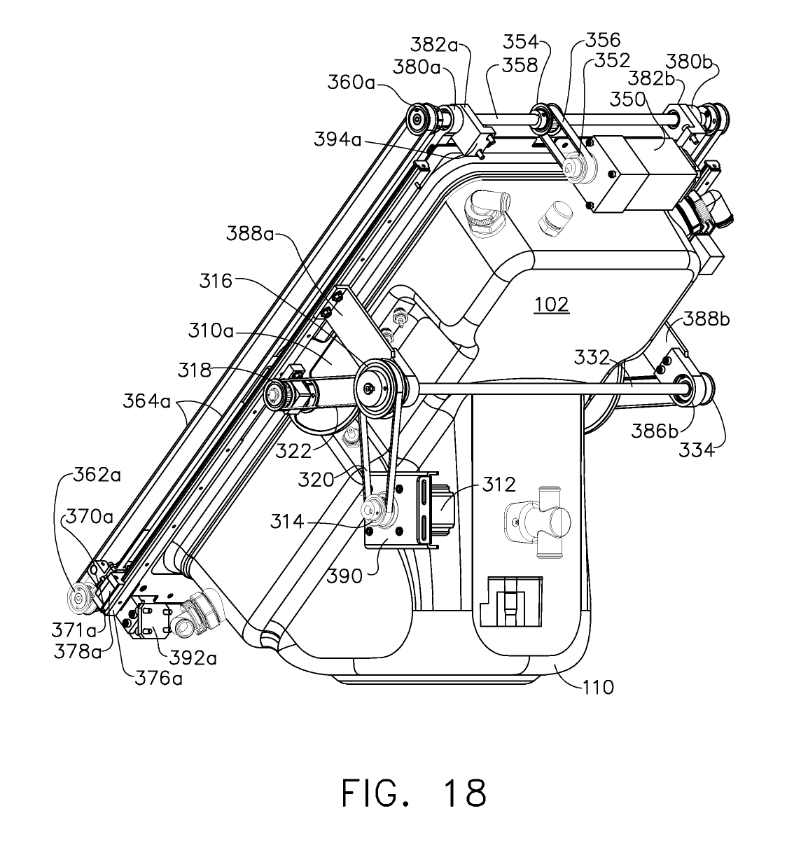

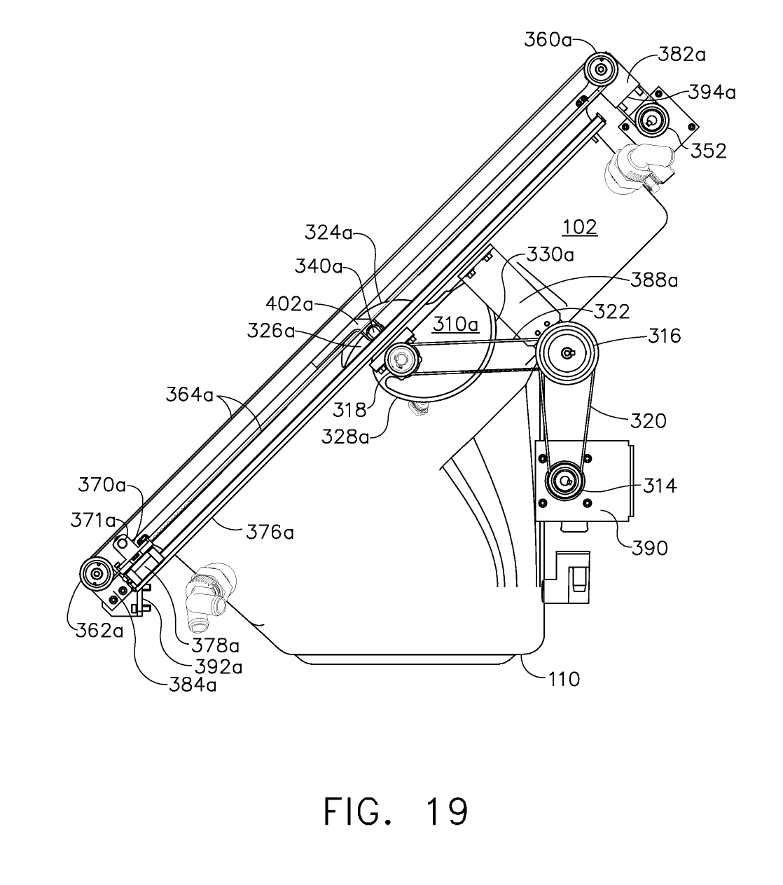

Referring to FIGS. 7-10, the instrument reprocessor 1 may further comprise at least one basin 100. In various embodiments, angled side 20 comprises a frame 60 wherein a basin 100 can extend into the interior of the instrument reprocessor 1 from frame 60 along a basin rim 104. Each basin 100 may be defined by a basin cavity 102 which can comprise basin sides 106, basin bottom 108, basin drain 110, and basin drain flange 112. Each basin 100 may further comprise a plurality of nozzles 150, 152, 154 and ports 170. A load carrier or basket 220, as illustrated in an exemplary embodiment shown in FIGS. 11-16, may fit within a basin 100. Basin 100 and load carrier 220 are described in greater detail below. In the exemplary embodiment shown in FIGS. 7-10, the instrument reprocessor 1 comprises two basins 100 wherein a load carrier 220 may be placed within each basin 100. In use, an instrument 200, such as an endoscope, for example, may be placed within a load carrier 220 and the load carrier 220 may fit within basin 100 of the instrument reprocessor 1. Referring to FIG. 48, an endoscope 101 is illustrated as being positioned within a carrier 220 which is positioned in a basin 100. In various embodiments, the endoscope 101 may comprise various portions or components 101a, 101b, and/0r 101c which can be supported within the carrier 220. The operation of the instrument reprocessor 1 is described in greater detail below.

Frame 60 may have a frame hinge 312 and a guide 322. Referring to FIGS. 7-10, a frame hinge 312 may be coupled to frame 60 near the upper edge of frame 60. In one embodiment, frame 60 may also have a guide 322 extending along a portion of basin rim 104. In another embodiment, frame 60 may comprise two or more guides which extend along frame 60 on opposite sides of basin 100 from near the upper edge of frame 60 to near the lower edge of frame 60. Instrument reprocessor 1 may also comprise a bi-fold lid assembly 300 or multiple bi-fold lid assemblies 300, described in greater detail below. Bi-fold lid assembly 300 may be hinged to frame 60 of angled side 20 at frame hinge 312. The right side of frame 60 may be the mirror image reflection of the left side of frame 60. Accordingly, the instrument reprocessor 1 may have a first bi-fold lid assembly 300 on the right side of frame 60 and a second bi-fold lid assembly 300 on the left side of frame 60, each covering a different basin 100.

The instrument reprocessor 1 comprises a bi-fold lid assembly 300 with an upper lid panel 302 and a lower lid panel 304. Upper lid panel 302 may be hingably connected to lower lid panel 304. The bi-fold lid assembly 300 is described in greater detail below.

As outlined above, each basin 100 may be positioned underneath a bi-fold lid assembly 300 in top portion 4. When upper lid panel 302 and lower lid panel 304 are closed, basin 100 may be hidden from view. In another embodiment, referring to FIG. 1, upper lid panel and/or lower lid panel 302 may comprise a transparent pane or panes 306 which reveal or partially reveal basin 100 when lid panels 302, 304 are closed. Further, basin 100 may be revealed when lid panels 302, 304 are open. In at least one embodiment, the instrument reprocessor 1 may have two bi-fold lid assemblies 300; right bi-fold lid assembly 300 may be a mirror image reflection of left bi-fold lid assembly 300. A first basin 100 may be positioned behind the right bi-fold lid assembly 300 and a second basin 100 may be positioned behind the left bi-fold lid assembly 300.

In another embodiment, the instrument reprocessor 1 may further comprise a control panel assembly 80. Referring to FIGS. 1-5, control panel assembly 80 may be located on frame 60 of angled side 20. Alternatively, control panel assembly 80 could be located on the front side 10, back side 12, right side 14, left side 16, and/or base 22 of the instrument reprocessor 1. In an alternative embodiment, control panel assembly 80 may be positioned at a control station which is remote with respect to the instrument reprocessor 1 and may communicate with the instrument reprocessor 1 by a wired and/or wireless connection. Control panel assembly 80 may have an input panel 84. In at least one embodiment, referring again to FIG. 1, control panel assembly 80 may have multiple input panels 84. Further, control panel assembly 80 may have a protective cover or multiple protective covers 82 to operably hide and reveal the input panel or panels 84. Control panel assembly 80 may also comprise a computer or video screen 86. In another embodiment, video screen 86 may be located on front side 10, back side 12, right side 14, left side 16, angled side 20, and/or base 22 of the instrument reprocessor 1. In one embodiment, screen 86 may not be located on control panel assembly 80. In various embodiments, screen 86 may provide a visual indication to the operator of the instrument reprocessing program (e.g., cleaning cycle, washing cycle, disinfection cycle, or sterilization cycle) and/or the conditions inside the instrument reprocessor 1. In various embodiments, control panel assembly 80 and screen 86 are positioned at a height that is easily viewable and accessible by the instrument reprocessor operator. The control panel assembly 80 and screen 86 are described in greater detail below.

As described above, the instrument reprocessor 1 may comprise a basin 100 or a plurality of basins 100. In at least one embodiment, referring to FIGS. 7-10, a first basin 100 may be positioned behind right bi-fold lid assembly 300 and a second basin 100 may be positioned behind left bi-fold lid assembly 300. As also described above, the arrangement and/or components of the first and second basins 100 may be substantially identical, as illustrated in embodiments shown in FIGS. 7-10. Alternatively, the arrangement and/or components of basins 100 may be mirror image reflections of each other. Referring to FIGS. 7-10, basins 100 further comprise a plurality of nozzles 150, 152, 154 and ports 170, which are described in greater detail below. In various circumstances, first basin 100 may comprise a different combination of nozzles 150, 152, 154 and/or ports 170 than second basin 100.

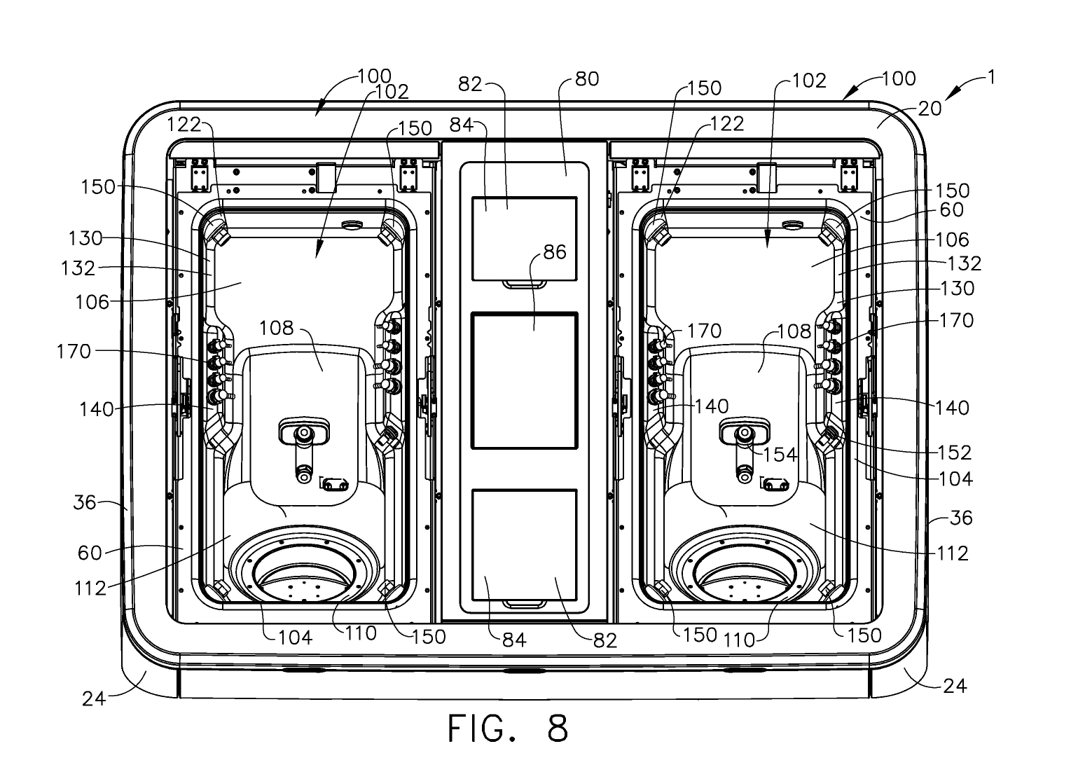

As described above, referring to FIG. 8, basin 100 extends into the instrument reprocessor 1 from frame 60 wherein frame 60 borders basin 100 along basin rim 104. As also described above, the basin cavity 102 is defined by basin sides 106, basin bottom 108, basin drain 110, and basin drain flange 112. Basin sides 106 may include a basin corner 122 wherein, referring to FIG. 8, basin corner 122 may be rounded, for example. Alternatively, basin corner 122 may be square, for example. In various embodiments, basin sides 106 may comprise a step 130 or a plurality of steps 130 wherein each step 130 may have a planar support surface 132 projecting from basin sides 106. As described in greater detail below, a load carrier 220 may fit within a basin 100 wherein a portion of a load carrier 220 may rest on support surfaces 132 of steps 130. In certain embodiments, basin cavity 102 may narrow from basin rim 104 to basin bottom 108.

Basin 100 may also comprise a protrusion or protrusions 140 extending from basin sides 106. According to one embodiment, referring to FIG. 8, basin 100 may have two protrusions 140 on opposite sides of basin 100—one extending from the right basin wall 124 and the other extending from the left basin wall 126. The opposite protrusions 140 may extend towards each other into basin cavity 102. Basin 100 may also have a corner nozzle 150. According to another preferred embodiment, referring to FIG. 8, basin 100 has four corner nozzles 150, one in each basin corner 122. Corner nozzle 150 may protrude from basin sides 106 between basin rim 104 and step 130. In an embodiment of the invention, corner nozzle 150 protrudes diagonally into basin cavity 102. Alternatively, basin 100 may not comprise a corner nozzle 150.

Basin 100 may also have a side nozzle 152. Side nozzle 152 may be positioned on protrusion 140. FIG. 7 illustrates side nozzle 152 on protrusion 140. Alternatively, side nozzle 152 may be positioned on basin side walls 106. Referring again to FIG. 7, side nozzle 152 may positioned on the side of protrusion 140 to diagonally project across basin cavity 102. Side nozzle 152 may be directed parallel to one of the corner nozzles 150. Alternatively, side nozzle 152 could direct straight across the basin 100 or at a different angle than corner nozzles 150. In various embodiments, side nozzle 152 may be positioned on the basin sides 106 between the basin rim 104 and step 130. In another embodiment, basin 100 may not comprise a side nozzle 152 or may comprise a plurality of side nozzles 152.

Referring again to FIGS. 7-10, basin 100 may further comprise a bottom nozzle 154 or a plurality of bottom nozzles 154. Bottom nozzle 154 may extend from basin bottom 108 into basin cavity 102. Bottom nozzle 154 may extend perpendicular to angled side 20 or may angle towards basin walls 106. In various embodiments, referring to FIG. 8, the instrument reprocessor 1 has two or more bottom nozzles 154. In at least one embodiment, bottom nozzles 154 may comprise a shared stem 156 protruding from basin bottom 108. A first bottom nozzle 154 may veer from shared stem 156 and bottom nozzles 154 may extend from basin bottom 108 in a Y-configuration, as illustrated in an embodiment shown in FIGS. 7-10. Alternatively, first and second bottom nozzles 154 may both veer from shared stem 156. In still another embodiment, bottom nozzles may veer from shared stem 156 in a T-configuration. In another embodiment, bottom nozzles 154 may not comprise a shared stem 156. In yet another embodiment, bottom nozzles may extend into basin cavity 102 in parallel. In use, as described in greater detail below, corner nozzle(s) 150, side nozzle(s) 152 and/or bottom nozzle(s) 154 direct disinfectant, for example, towards surgical instrument 200 placed in load carrier 220 positioned within basin 100.

Basin 100 may also comprise a plurality of ports 170. Referring to FIG. 8, ports 170 protrude from protrusion 140 on the right basin wall 124 and left basin wall 126. In another embodiment, referring to FIG. 8, basin 100 comprises eight ports 170. In use, as described in greater detail below, flexible tubes can connect ports 170 to channels defined in a surgical instrument. Any port or ports 170 not connected to a channel 204 by a flexible tube 214 may be sealed with a port cap. During an operating cycle of the instrument reprocessor 1, disinfectant is flushed from ports 170 through flexible tubes 214 and into the surgical instrument. In various alternative embodiments, basin 100 may comprise any suitable number of ports 170. Additionally, in various embodiments, ports 170 can be positioned on basin sides 106 within an accessible range of the instrument. Conduits and connectors used to sealingly engage flexible conduits to an endoscope are described in U.S. patent application Ser. No. 12/998,459, entitled FLUID CONNECTOR FOR ENDOSCOPE REPROCESSING SYSTEM, which was filed on Aug. 29, 2011 and U.S. patent application Ser. No. 12/998,458, entitled QUICK DISCONNECT FLUID CONNECTOR, which was also filed on Aug. 29, 2011, the entire disclosures of which are incorporated by reference into this specification.

Basin cavity 102 may be further defined by a drain flange 112. Referring to FIG. 8, drain flange 112 extends between basin bottom 108 and basin sides 106. Drain flange 112 is preferably positioned in the lower portion of basin 100 and comprises a downward sloping surface towards drain 110. In various embodiments, drain 110 is positioned in the lowest portion of basin 100. In use, as described in greater detail below, fluid from nozzles 150, 152, 154 and the instrument channels may be emptied from basin 100 by passing through drain 110 into a recirculation system of the instrument reprocessor 1.

As described above, the instrument reprocessor 1 may also comprise a load carrier or basket 220 for holding a surgical instrument, such as an endoscope, for example, within a basin 100 of the instrument reprocessor 1. Referring to FIGS. 11-16, load carrier 220 may be a lattice mesh of support rods 222 wherein the support rods 222 may be comprised of any suitable material capable of withstanding the conditions within the instrument reprocessor 1. Non-limiting examples of suitable materials include stainless steels such as, for example, 300 series stainless steels. In various embodiments, the distance between latticed support rods 222 is maximized in order to minimize the surface area of contact between the surgical instrument and load carrier 220. In at least one embodiment, referring again to FIG. 11, support rods 222 may have a circular cross section, for example, to minimize the surface area of contact between the surgical instrument 200 and load carrier 220. Though support rods 222 of load carrier 220 shown in FIGS. 8-13 have a circular cross section, the invention is not limited to this embodiment and support rods 222 may have any other suitable cross section, such as oval or polygonal cross sections, for example.

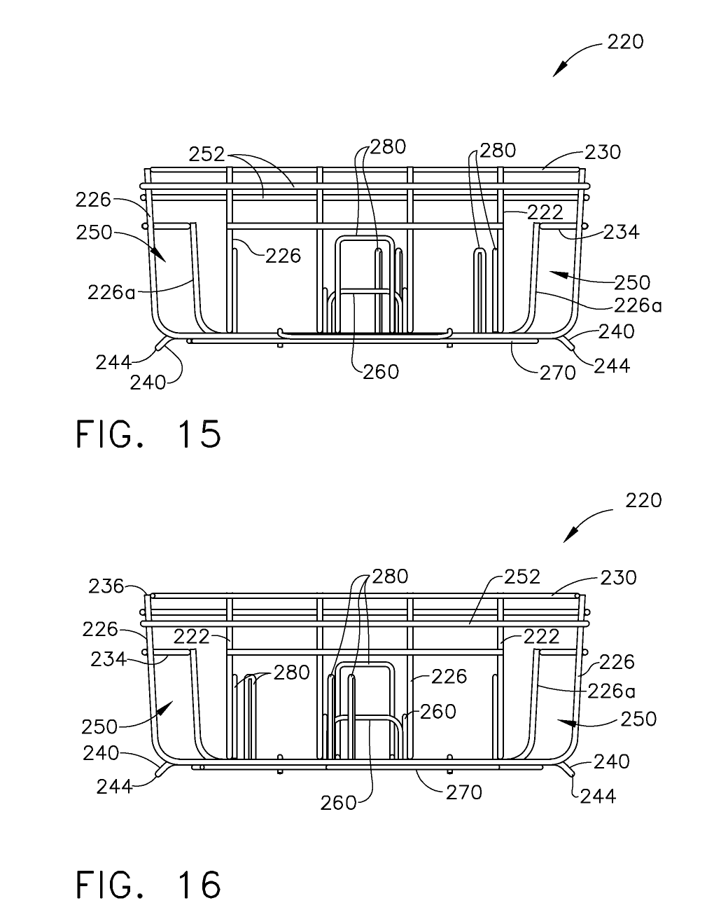

Support rods 222 may form a carrier bottom 224 and carrier side 226. Carrier side 226 may extend from the perimeter of carrier bottom 224. Referring again to FIG. 11, a support rod 222 may bend between the carrier bottom 224 and carrier side 226. Referring to FIG. 13, support rods 222 may bend along a radius of curvature R between the carrier bottom 224 and carrier side 226. The radius of curvature R may be uniform with respect to all of the support rods 222 or it may be different.

Load carrier 220 may also have an upper rim 230. In various embodiments, referring to FIG. 11, upper rim 230 may incline upwardly from carrier bottom 224 and inwardly from carrier side 226. In some circumstances, upper rim 230 may provide a barrier between a surgical instrument positioned within the load carrier 220 and basin 100. In use, as described in greater detail below, the configuration of the upper rim 230 may require that the operator remove the surgical instrument from the load carrier 220 in a manner which reduces the possibility that the instrument may contact the basin 100 and/or another portion of the instrument reprocessor 1. In certain circumstances, the upwards and inwards incline of the upper rim 230 may induce the operator to lift the surgical instrument away from the basin sides 106 when removing the surgical instrument from the load carrier 220.

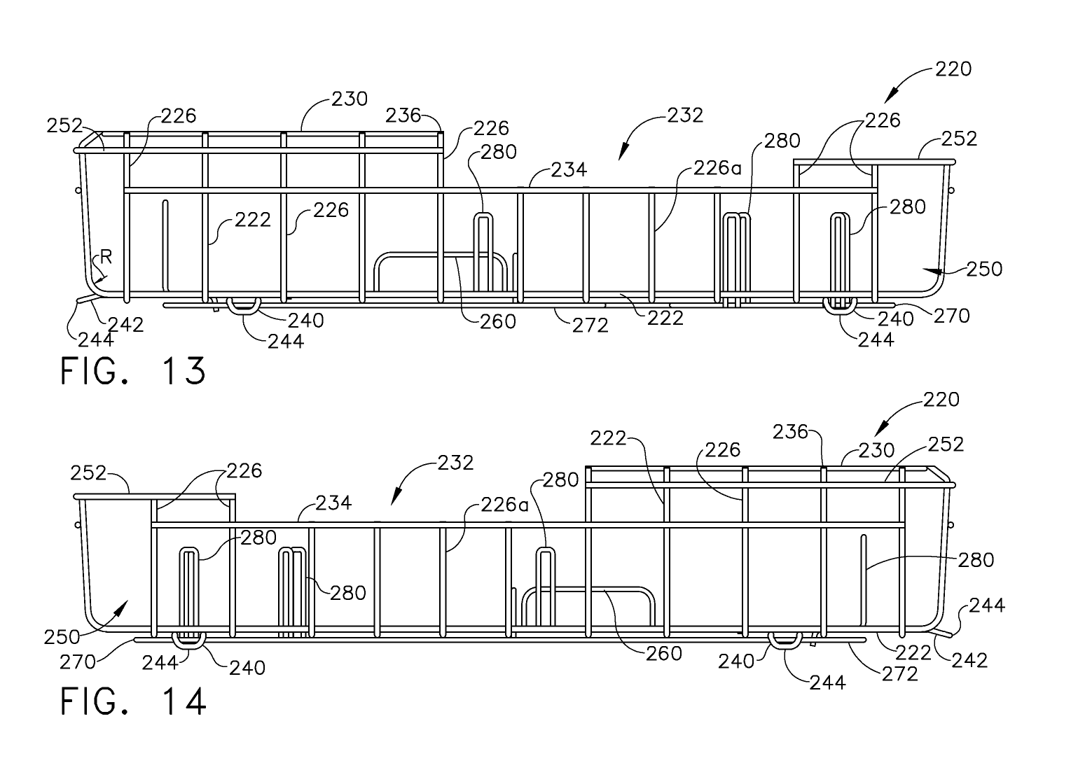

In various embodiments, load carrier 220 may comprise a necked portion 232. Referring to FIGS. 11-16, support rods 222 can form a narrower carrier bottom 224a and a shorter carrier side 226a in necked portion 232. In various embodiments, the load carrier 220 may comprise one necked portion 232 or more than one necked portion 232. Referring to FIGS. 11-14, load carrier 220 comprises a necked portion 232 on a first side of load carrier 220 and a second necked portion 232 on a second side of load carrier 220 opposite to the first side. Load carrier 220 may further comprise a longitudinal rod 234 which may intersect support rods 222 along carrier side 226a of necked portion 232 at or near rod end 236 and may intersect support rods 222 outside the necked portion 232 intermediate to the rod end 236 and carrier bottom 224. Referring to FIG. 12, longitudinal rod 234 may angle inwards from the carrier side 226 in necked portion 232.

In various embodiments, further to the above, the necked portions 232 can be sized and configured to accommodate protrusion or protrusions 140 of a basin 100 when the load carrier 220 is positioned within a basin 100. In certain embodiments, the inwards angle of longitudinal rod 234 may complement the contour of protrusion 140. Further, the shorter carrier side 226 may allow the operator to route the flexible supply tubes, discussed above, from the ports 170 on basin sides 106 into the load carrier 220 such that the flexible tubes can be attached to the instrument, such as an endoscope, for example, positioned therein. In various embodiments, the necked portions 232 on load carrier 220 can position the surgical instrument within the load carrier 220 in a position which is spaced apart from the basin sides 106.

In various embodiments, the load carrier 220 may comprise one or more support legs 240. In an exemplary embodiment, referring to FIGS. 11-16, a support leg 240 can extend across the carrier bottom 224 and can curve downwardly away from the carrier bottom 224. In at least one embodiment, each support leg 240, as exemplified in an embodiment illustrated in FIG. 11, can curve away from the bottom 224 on both sides of the load carrier 220 and can comprise two contact points 244. Alternatively, side leg 240 may not comprise a contact point 244, may comprise one contact point 244, or may comprise more than two contact points 244. Referring again to FIG. 11, load carrier 220 may comprise two or more side legs 240. As illustrated in FIG. 11, side leg 240 may comprise a wire loop welded to the bottom 224. In various embodiments, side leg 240 may comprise the same material as the latticed support rods 222. In use, as described in greater detail below, the side legs 240 can contact basin sides 106 to support a load carrier 220 when the load carrier 220 is positioned within a basin 100.

Load carrier 220 may also comprise at least one front leg 242. In an exemplary embodiment, referring to FIGS. 11-16, front leg 242 extends from the carrier bottom 224 at the proximate end of load carrier 220. Front leg 242, as exemplified in FIG. 11, provides one contact point 244 when the load carrier 220 is positioned within a basin 100. Alternatively, front leg 242 may not comprise a contact point 244 or may comprise more than one contact point 244. As shown in an embodiment illustrated in FIG. 11, front leg 242 may comprise a loop of material. In various embodiments, front leg 242 may comprise the same material as the latticed support rods 222. In use, as described in greater detail below, front leg 242 can contact a proximal basin side 106 to support the load carrier 220 when the load carrier 220 is positioned within the basin 100. When load carrier 220 is positioned within basin 100 as exemplified in an embodiment illustrated in FIGS. 7-10, the proximate end of load carrier 220 is tilted downwards relative to the distant end of load carrier 220. Accordingly, the front leg 242 can hold the instrument positioned within the tilted load carrier 220 away from proximate basin side 106.

In various embodiments, load carrier 220 may comprise one or more spray disruption minimizers. In at least one embodiment, a spray disruption minimizer may comprise a window 250 in a corner of the load carrier 220. In at least one such embodiment, a window 250 can be defined by a top rod 252 which can intersect support rods 222 extending upwardly along the sides of the carrier. In use, as described in greater detail below, the window 250 may permit a fluid to be sprayed onto the instrument positioned within the load carrier from a nozzle, such as nozzles 150 or 152, for example, without disrupting, or at least minimizing the disruption of, the spray.

In various embodiments, further to the above, the load carrier 220 may also comprise a window defined in the bottom 224 configured to permit a spray of fluid therethrough. In at least one embodiment, the window can be at least partially defined by an elongate loop 260 defined in the carrier bottom 224. Referring to FIG. 11, elongate loops 260 may extend outwardly from a support rod 222. Similar to the above, the elongate loop 260 may be configured to minimize spray disruption from a nozzle, such as bottom nozzles 154, for example.

Optionally, load carrier 220 may comprise an instrument position guide 270. Instrument position guide 270 may be defined within, integrally formed with, and/or fixedly attached to the carrier bottom 224. According to multiple embodiments, instrument position guide 270 may be defined in the load carrier 220 or attached to the underside of load carrier 220. In at least one embodiment, instrument position guide 270 may be comprised of the same material as the latticed support rods 222. In various embodiments, the instrument position guide 270 provides the operator with a template for positioning a surgical instrument, such as an endoscope, in the load carrier 220. In use, as described in greater detail below, the operator positions the instrument head 202 in a Y-joint 274 and aligns the rest of instrument with the instrument position guide 270. In various embodiments, instrument position guide 270 may guide the operator to position the endoscope in a manner which optimally, or at least suitably, aligns the endoscope relative to the spray nozzles 150, 152, and/or 154, for example. In certain embodiments, the instrument position guide 270 can guide the operator to appropriately distribute the weight of the endoscope in the load carrier 220 and/or arrange the endoscope in an ergonomically preferred position.

Further to the above, instrument position guide 270 may comprise a ring 272 which may comprise arc segments and/or straight segments and may comprise arc segments with consistent and/or varying radii of curvature. Ring 272 may be in the proximate part of the carrier bottom 224. Instrument position guide 270 may also comprise a Y-joint 274 extending from ring 272. Referring to FIG. 12, in at least one embodiment, Y-joint 274 may extend diagonally towards the distal part of carrier bottom 224. Instrument position guide 270 may further comprise an extension 276. Extension 276 may extend from Y-joint 274 towards the opposite side of the carrier bottom 224.

In various embodiments, load carrier 220 may further comprise posts 280 extending upwards from the carrier bottom 224. A plurality of posts 280 may be adjacent to the instrument position guide 270. Additionally or alternatively, a plurality of posts 280 may be positioned around the circumference of carrier bottom 224. Referring to an embodiment of FIG. 11, three posts 280 are adjacent to Y-joint 274 and four posts 280 are positioned around the circumference of the carrier bottom 224. The arrangement of posts 280 in FIG. 11 is merely illustrative and is not intended to limit the scope of the invention. Posts 280 may comprise loops of material. Further, posts 280 may comprise the same material as the latticed support rods 222. Referring to FIG. 11, posts 280 may be narrow, such as those posts 280 adjacent to Y-joint 274, and/or wider in various alternative embodiments.

During use, as described in greater detail below, posts 280 may guide and constrain instrument 200 in a preferred position in load carrier 220. Posts 280 may guide instrument into a position that retains instrument 200 away from basin walls 106. In various embodiments, posts 280 correspond with instrument position guide 270. Posts 280 may constrain instrument in a position that appropriately distributes the weight of the instrument 200 in the load carrier 220 and/or may facilitates easy connection of flexible tubes 214 to ports 170.

In use, the operator may approach the instrument reprocessor 1 from the front. In another preferred embodiment, as described above, pedestal 2 may reach to approximately the operator's waist height, for example, and angled side 20 may extend from approximately the operator's waist height upwards at an angle. As described above, in various embodiments, angled side 20 may be positioned upwards at approximately forty-five degrees. The height of pedestal 2 and the angle of angled side 20 may be ergonomically designed to improve the operator's ease of use. In another embodiment, the height of pedestal 2 and the angle of angled side 20 may position the bi-fold lid assembly 300 and the basins 100 within the operator's unstrained reach.

The operator may open bi-fold lid assembly 300 and place surgical instrument 200 in load carrier 220. In various embodiments, the operator can position the head of the endoscope above Y-joint 274 of the instrument position guide 270 and align the rest of the endoscope with ring 272 and extension 276 such that the posts 280 can support the endoscope within load carrier 220. As described above, the operator may then connect flexible tubes to the channels of the endoscope. The operator may then close bi-fold lid assembly 300. The operator may provide input to control panel assembly 80 wherein screen 86 can provide a visual indication of the instrument reprocessing program and/or the conditions inside the instrument reprocessor 1 to the operator. In various embodiments, control panel assembly 80 and screen 86 are positioned at a height that is easily viewable and accessible to the operator.

In various embodiments, the screen 86 may comprise a graphical user interface (GUI). The GUI may be configured for input/output communication to control/monitor one or more basins comprising an instrument reprocessor. For example, in embodiments comprising two basins, a GUI may be configured for simultaneous input/output communication to control/monitor both basins. In other embodiments comprising two basins, a GUI may be configured to allow the selection of one of the basins, wherein once a basin is selected, the GUI is configured for input/output communication to control/monitor the selected basin.

According to the operator's input, the instrument reprocessor 1 may run an instrument reprocessing program, which may comprise one or more of washing, cleaning, decontaminating, disinfecting, and/or sterilizing an instrument, such as, for example, an endoscope. Upon completion, the operator may open bi-fold lid assembly 300, as described in greater detail below, and remove the endoscope from load carrier 220. Before removing instrument 200, the operator may disconnect flexible tubes 214 from instrument channels 204. As discussed above, upper rim 230 of load carrier 220 can encourage the operator to carefully remove the endoscope from load carrier 220 to prevent the endoscope from contacting the sidewalls of the basin and possibly contaminating the endoscope. Upper rim 230 may induce the operator to confine the reprocessed instrument 200 and lift instrument 200 upwards and out of load carrier 220 before drawing the instrument 200 forward and out of the instrument reprocessor 1. Lifting the instrument 1 upwards before drawing the instrument 1 forward may prevent part of instrument 200 from contacting basin 100 and will reduce the likelihood of contamination. After removing the reprocessed instrument 200 from the instrument reprocessor 1, the operator may close bi-fold lid assembly 300, as described in greater detail below.

During a reprocessing program, fluid comprising one or more of water, an alcohol solution, a detergent, a disinfectant solution, and/or a sterilant, for example, may spray or otherwise discharge from corner nozzles 150, side nozzles 152, and/or bottom nozzles 154. Additionally, fluid may flush from ports 170 through the flexible tubes and into the channels defined in the endoscope. Sprayed and flushed fluid may then drain into basin 100. More specifically, fluid may drain along basin sides 106, basin bottom 108, and drain flange 112. In various embodiments, drain 110 is located in a lower portion of basin 100. Drain flange 112 may slope downwards towards drain 110. Fluid may then flow through drain 110 and the instrument reprocessor 1 may recycle and reuse drained fluid or suitably dispose of the fluid after a single reprocessing cycle.

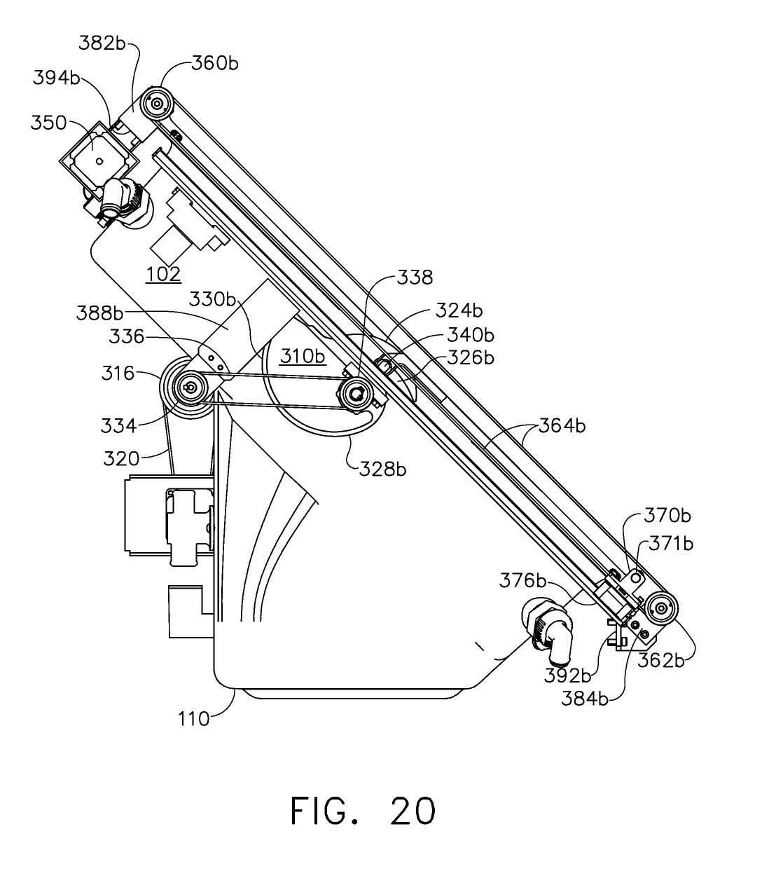

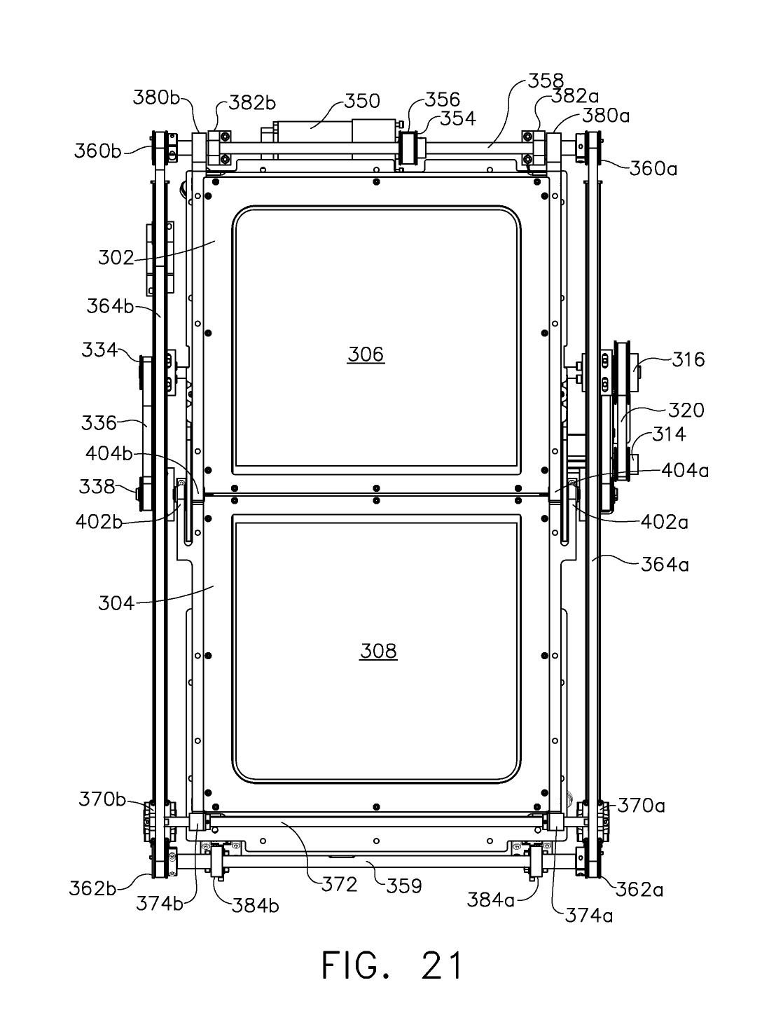

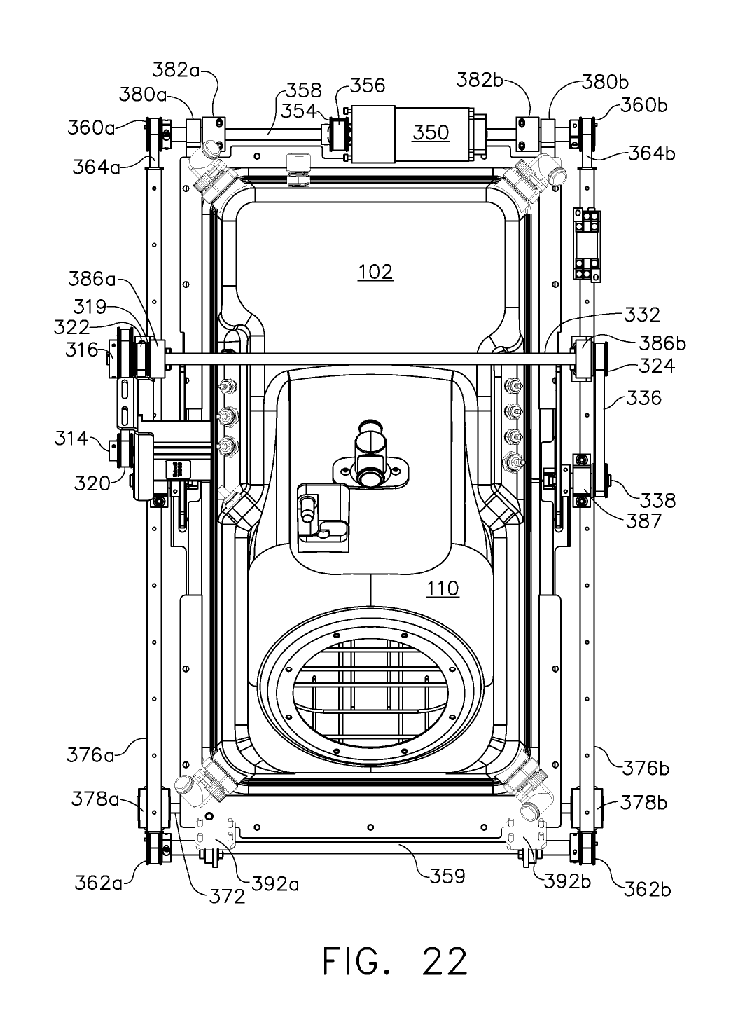

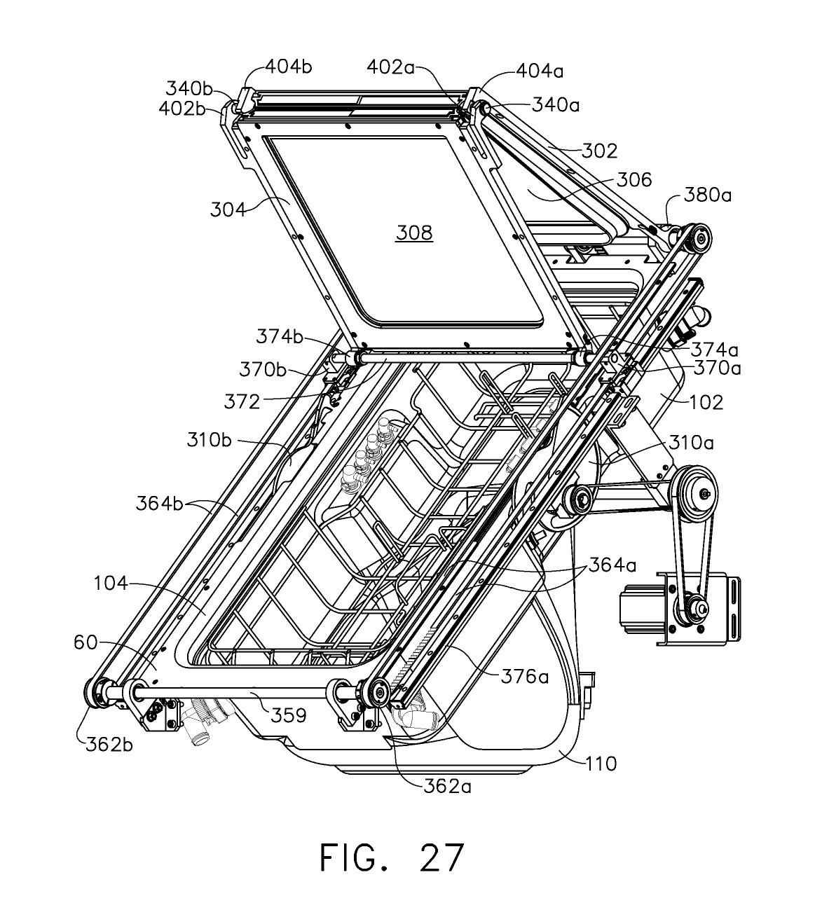

As discussed above, the instrument reprocessor 1 can comprise at least one basin and at least one lid, wherein the lid can be configured to cover the basin while a medical instrument, such as an endoscope, for example, is being cleaned, sterilized, and/or otherwise disinfected within the basin. An embodiment of a bi-fold lid 300 is illustrated in FIGS. 17-22. The bi-fold lid 300 includes an upper lid panel 302 and a lower lid panel 304. In various embodiments, the upper lid panel 302 optionally includes a window pane 306 and the lower lid panel 304 optionally includes a window pane 308. In use, the lid 300 can be moved between a closed position, illustrated in FIG. 17, and an open position, illustrated in FIG. 27. In the closed position of the bi-fold lid 300 (FIG. 17), the bi-fold lid 300 can be sealed against the frame 60 surrounding the basin, as described in greater detail below. In various embodiments, as also described in greater detail below, the upper lid panel 302 can be hingedly connected to the frame 60 of the instrument reprocessor 1. In at least one embodiment, the frame 60 can comprise bearings 382a and 382b which can be configured to rotatably attach the upper lid panel 302 to the frame 60. More specifically, in at least one embodiment, the instrument reprocessor 1 can further comprise a shaft 358 which can be rotatably supported by the bearings 382a, 382b wherein the upper lid panel 302 can also comprise one or more bearings, such as bearings 380a and 380b, for example, which are rotatably attached to the shaft 358. In various embodiments, the bearings 380a, 380b, 382a, and/or 382b may comprise any suitable type of bearings, such as journal bearings, sleeve bushings, and/or pillow blocks, for example. In any event, as a result of the above, the bearings 382a, 382b and the shaft 358 can support an end of the upper lid panel 302 and the bearings 380a, 380b can permit relative rotational movement of the upper lid panel 302 about the shaft 358.

The upper lid panel 302 also can be hingedly connected to the lower lid panel 304. In various embodiments, the upper lid panel 302 can be connected to the lower lid panel 304 by pins 340a and 340b which can permit relative rotation between the upper lid panel 302 and the lower lid panel 304 about the pins 340a and 340b. In at least one embodiment, the pin 340a can extend through a portion of the upper lid panel 302 and the lower lid panel 304 on a first side thereof and, similarly, the pin 340b can extend through the upper lid panel 302 and the lower lid panel 304 on a second side thereof. In at least one such embodiment, the upper lid panel 302 can comprise a first hinge arm 404a extending from the first side of the upper lid panel 302 which, one, can comprise a pin aperture aligned with a pin aperture in a second hinge arm 402a extending from the lower lid panel 304 and, two, can be rotatably pinned to the second hinge arm 402a by pin 340a. Similarly, the upper lid panel 302 can comprise a second hinge arm 404b extending from the second side of the upper lid panel 302 which, one, can comprise a pin aperture aligned with a pin aperture in a second hinge arm 402b extending from the lower lid panel 304 and, two, can be rotatably pinned to the second hinge arm 402b by pin 340b.

As described above, the upper lid panel 302 can comprise a first end rotatably mounted to the shaft 358 and a second, or opposite, end rotatably mounted to the lower lid panel 304. In at least one such embodiment, the second end of the upper lid panel 302 can be rotatably mounted to a first end of the lower lid panel 304. Further to the above, the lower lid panel 304 can comprise a second end which is slidably mounted to the frame 60. Referring to FIGS. 17 and 27, the second end of the lower lid panel 304 can be slid along a path between a first position in which the lid 300 is closed and a second position in which the lid 300 is open. In certain embodiments, the lower lid panel 304 can comprise one or more followers, such as followers 378a and 378b, for example, which can be configured to slide within channels, guides, and/or slots extending along the sides of the basin. In at least one embodiment, the frame 60 can comprise a first guide rail 376a extending along a first side of the basin and a second guide rail 376b extending along a second side of the basin, wherein the follower 378a, which can be positioned on the first side of the lower lid panel 304, can be slidably engaged with the first guide rail 376a and the follower 378b, which can be positioned on the second side of the lower lid panel 304, can be slidably engaged with the second guide rail 376b. In various embodiments, the guide rails 376a, 376b and the followers 378a, 378b can comprise co-operating geometries which can be configured to permit the followers 378a, 378b to slide longitudinally along the guide rails 376a, 376b, respectively and, yet, limit movement of the followers 378a, 378b in directions which are transverse to the longitudinal direction, or axes, of the guide rails 376a, 376b.

In various embodiments, further to the above, the lower lid panel 304 can be slid upwardly toward the top of the basin. In such circumstances, the lower lid panel 304 can rotate from a first, or closed, position in which it lies in a plane which is parallel, or at least substantially parallel, to a plane which includes the guide rails 376a and 376b into a second position in which the lower lid panel is oriented in a direction which is transverse to these planes. To accommodate such movement of the lower lid panel 304, the followers 378a, 378b may be rotatable relative to the generally planar cover portion of the lower lid panel 304. In at least one such embodiment, the lower lid panel 304 can include bearings 374a and 374b and a shaft 372 supported by the bearings 374a and 374b, wherein the followers 378a, 378b can be mounted to opposite ends of the shaft 372. In various embodiments, the followers 378a, 378b can be fixedly mounted to the shaft 372 and the shaft 372 can be configured to rotate relative to the bearings 374a and 374b. In certain embodiments, the followers 378a, 378b can be mounted to the shaft 372 such that the followers 378a, 378b can rotate relative to the shaft 372. In either event, such embodiments can permit the relative rotational movement between the planar cover portion and the followers 378a, 378b of the lower lid panel 304.

In order to open the bi-fold lid 300, further to the above, an operator of the instrument reprocessor 1 can apply a force to the lower lid panel 304 which tends to slide the followers 378a, 378b along their respective guide rails 376a, 376b. In certain embodiments, the instrument reprocessor 1 can further comprise a system which can assist the operator in opening the lid 300. In at least one such embodiment, the instrument reprocessor 1 can further comprise a motor and a belt drive system, for example, which can be configured to pull the followers 378a, 378b upwardly. Referring primarily to FIG. 18, the endoscope reprocessor 1 can include a motor 350, a drive pulley 352 operably engaged with a drive shaft of the motor 350, and a belt 356 which can be operably engaged with the shaft 358, discussed above, such that, when the drive pulley 352 is rotated by the motor 350, the shaft 358 also rotates. In at least one such embodiment, the shaft 358 can include a pulley 354 mounted thereto which can be driven by the belt 356. Although a belt drive system is disclosed herein, any other suitable drive system could be used, such as a chain drive system including a chain and drive sprockets, for example. In certain embodiments, the shaft 358 also may include pulleys 360a and 360b mounted thereto on opposite sides thereof which can be configured to rotate with the shaft 358. In various embodiments, the pulleys 360a, 360b can be part of a second belt drive system which can be operably engaged with the followers 378a and 378b. In at least one such embodiment, the instrument reprocessor 1 can comprise, one, a shaft 359 rotatably mounted to the frame 60 by bearings 384a and 384b and, two, pulleys 362a and 362 mounted to opposite ends of the shaft 359, wherein pulley 362a can be operably coupled to pulley 360a by belt 364a and wherein pulley 362b can be operably coupled to the pulley 360b by belt 364b. In such embodiments, the follower 378a can comprise a connector portion 370a mounted to the belt 364a such that, when the belt 364a is driven by the motor 350, the belt 364a can pull the follower 378a upwardly and, similarly, the follower 378b can comprise a connector portion 370b mounted to the belt 364b such that, when the belt 364b is driven by the motor 350, the belt 364b can pull the follower 378b. In various embodiments, the belt drives positioned on opposite sides of the basin 102 can be symmetrical, or at least substantially symmetrical, such that the followers 378a and 378b can be pulled upwardly in unison to open the lid 300. Correspondingly, the motor 350 may be driven in the opposite direction, or reversed, in order to pull the followers 378a and 378b downwardly in unison in to close the lid 300.

As discussed above, the lid 300 can be moved between a first position in which the upper lid panel 302 and the lower lid panel 304 are substantially flat into a second, folded position. In various embodiments, the upper lid panel 302 and the lower lid panel 304 can lie in a plane when the lid 300 is in a closed position. In such circumstances, however, the upper lid panel 302 and the lower lid panel 304 may resist being moved into their folded position. More specifically, the upper lid panel 302 and the lower lid panel 304 can be aligned in an end-to-end, or columnar, arrangement wherein a force F transmitted to the lower lid panel 304 via the drive system described above, for example, the force F would act straight through the column and may not act to rotate the lid panels 302 and 304 relative to each other. Potentially, the upper lid panel 302 and lower lid panel 304 may be arranged in a position which is slightly past a planar orientation, wherein the edges of the panels 302, 304 closest to the pins 340a and 340b are closer to the frame 60 than the ends of the panels 302, 304 nearest the bearings 380a, 380b and 374a, 374b, respectively. Stated another way, in such circumstances, the lid panels 302 and 304 can be in a phase lock which could prevent the lid panels 302, 304 from moving into their open positions or possibly require applying an excessive force to do so. As described in greater detail below, the instrument reprocessor 1 can comprise a system which can bias the door 300 into an at least partially open position, thereby potentially avoiding these conditions.

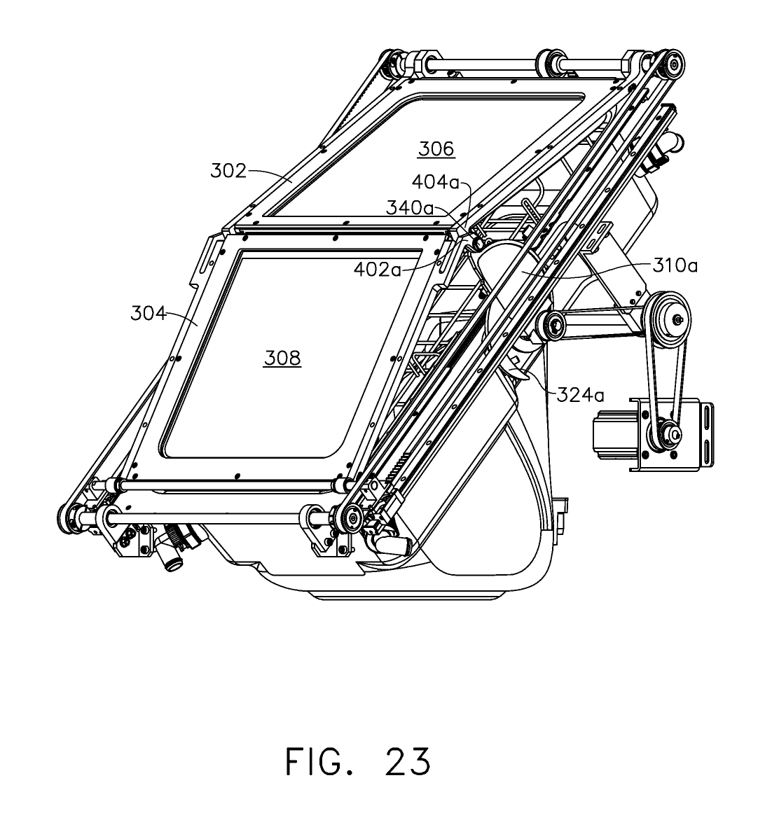

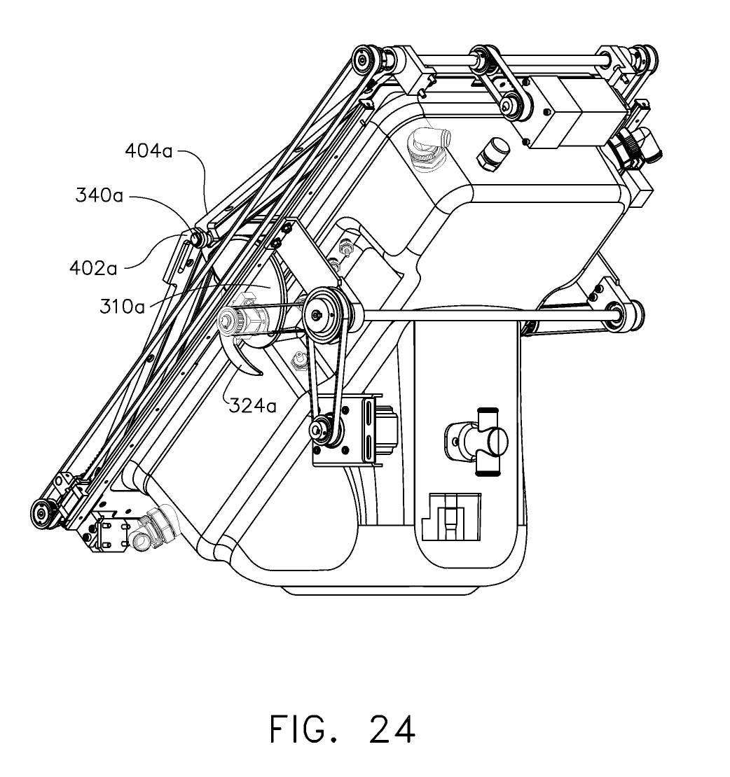

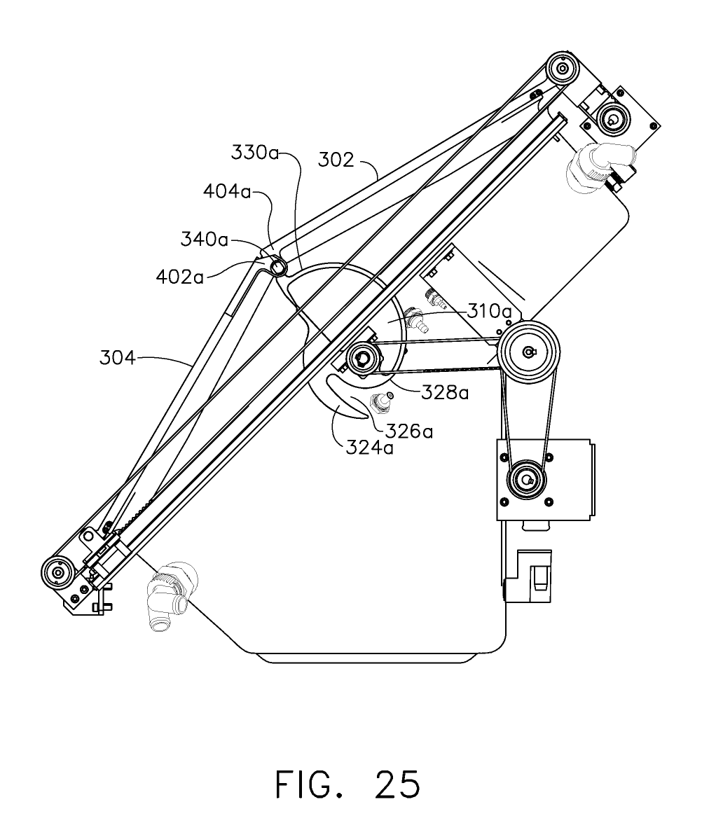

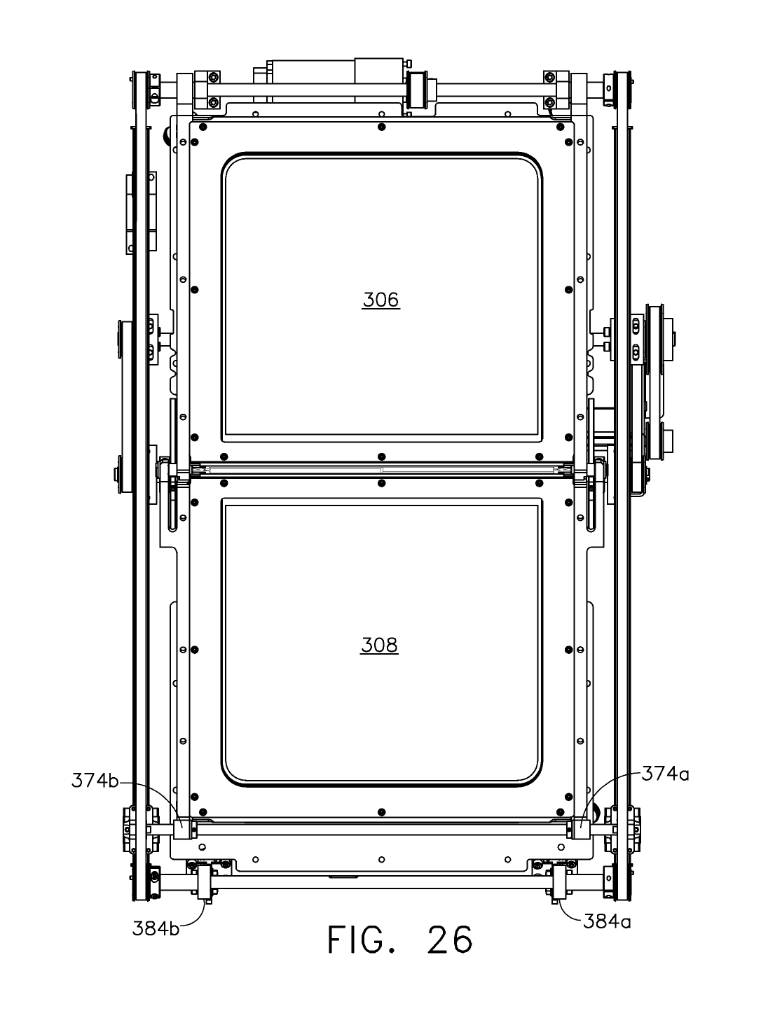

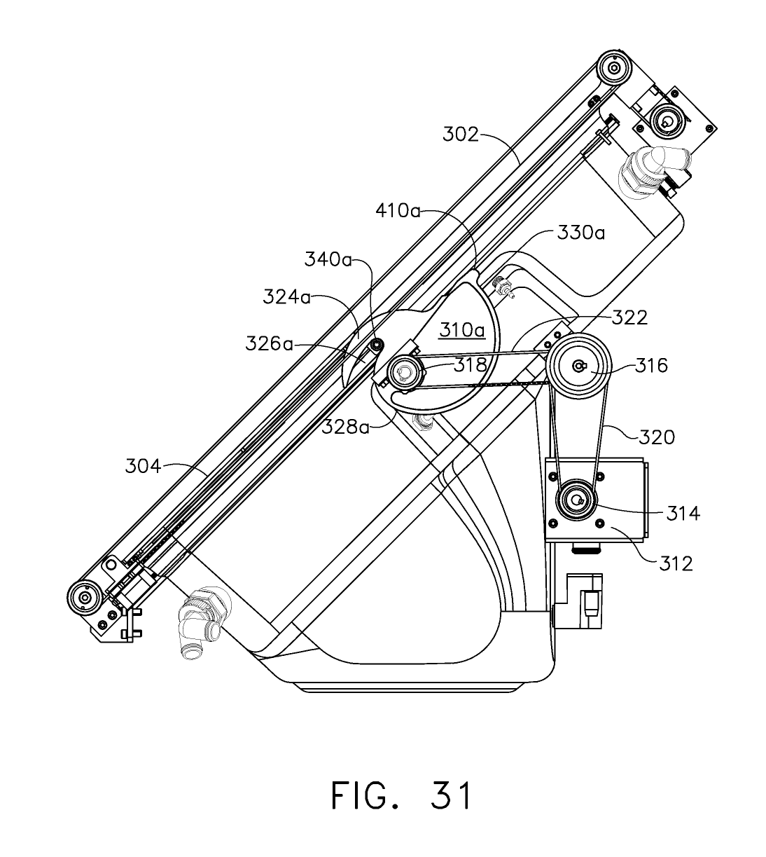

In various embodiments, further to the above, the instrument reprocessor 1 can further comprise one or more actuators, such as rotatable cams 310a and 310b, for example, which can be configured to bias the door 300 into a partially-open position, as illustrated in FIGS. 23-26. Such cams, in various embodiments, can also be configured to lock the door 300 in its closed position. In at least one such embodiment, a first cam 310a can be disposed on the first side of the basin 102 and a second cam 310b can be disposed on the second side of the basin 102. Referring primarily to FIG. 31, the cam 310a can include a locking finger 324a which defines a locking channel 326a configured to receive the hinge pin 340a therein. Similarly, the cam 310b can include a locking finger 324b which defines a locking channel 326b configured to receive the hinge pin 340b therein. In use, the cams 310a, 310b can be rotated into a locked position, as illustrated in FIG. 31, in which the sidewalls of the locking channels 326a, 326b can prevent the pins 340a, 340b, from rising upwardly from the surface frame 60. In such circumstances, the lid panels 302, 304 may be pressed against the basin rim 104 and may not be movable between their closed configuration and an open configuration. In various embodiments, the basin rim 104 and/or the lid panels 302, 304 may include a compressible seal which can be configured to permit the lid panels 302, 304 to sealingly engage the basin rim 104 and inhibit fluids from passing there between.

In various circumstances, further to the above, the cams 310a and 310b can be rotated out of their locked positions. In at least one embodiment, the cam 310a may include a pulley 318 fixedly mounted thereto which can be driven by an electric motor 312 via a belt and pulley systems including pulleys 314, 316, 319 and belts 320, 322. More specifically, the pulley 314 can be connected to a driveshaft of the motor 312 wherein the belt 320 can be driven by pulley 314. Correspondingly, the pulley 319 can be fixedly mounted to and rotate with pulley 316, and the belt 320 can drive the pulleys 316 and 319. The belt 322 can be operably engaged with the pulley 319 and the pulley 318 such that the rotation of the pulley 319 by belt 320 can drive belt 322 and rotate the pulley 318 and the cam 310a mounted thereto. In various embodiments, the motor 312 can also be configured to rotate the cam 310b. In at least one embodiment, the pulleys 316, 319 can be mounted to a first end of a shaft 222 which can extend behind the basin cavity 102 and can be rotatably supported by bearings 386a and 386b, for example. In at least one such embodiment, a pulley 334 can be mounted to the opposite, or second, end of the shaft 322 which can be rotated by the shaft 322. Similar to the above, the cam 310b can include a pulley 338 which can be operably engaged with the pulley 334 via a belt 336. As a result of the above, the motor 312 can drive the shaft 322 which can rotate the cams 310a and 310b into and out of their locked positions. In various embodiments, the belt and pulley system which operably connects the first cam 310a to the shaft 322 can be identical, or at least substantially identical, to the belt and pulley system which operably connects the second cam 310b to the shaft 322. In at least one such embodiment, the pulley 319 can have the same diameter as the pulley 334 and, in addition, the pulley 318 can have the same diameter as the pulley 338 such that cams 310a and 310b rotate in unison.

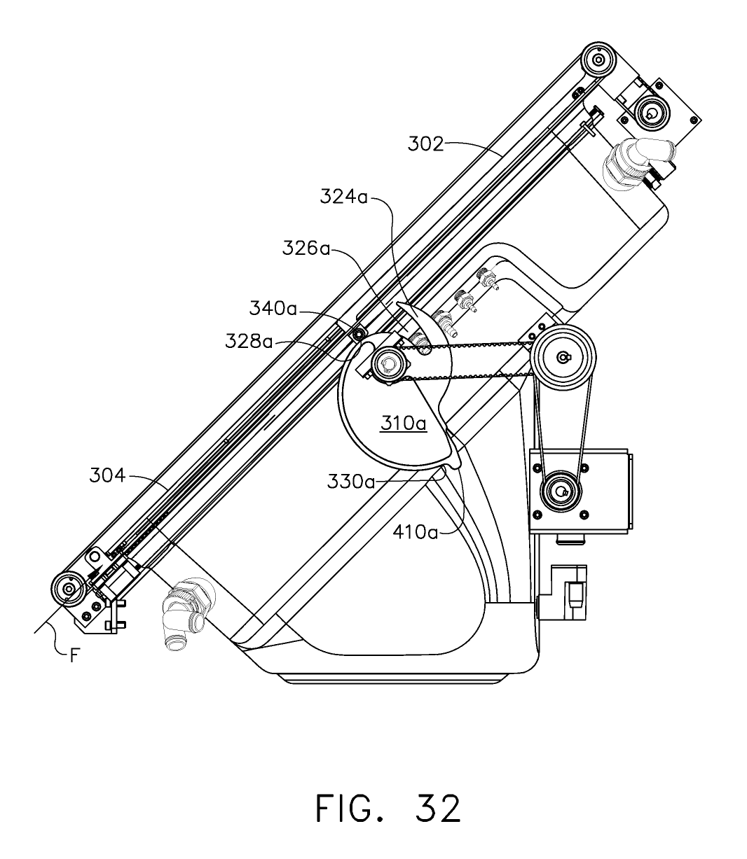

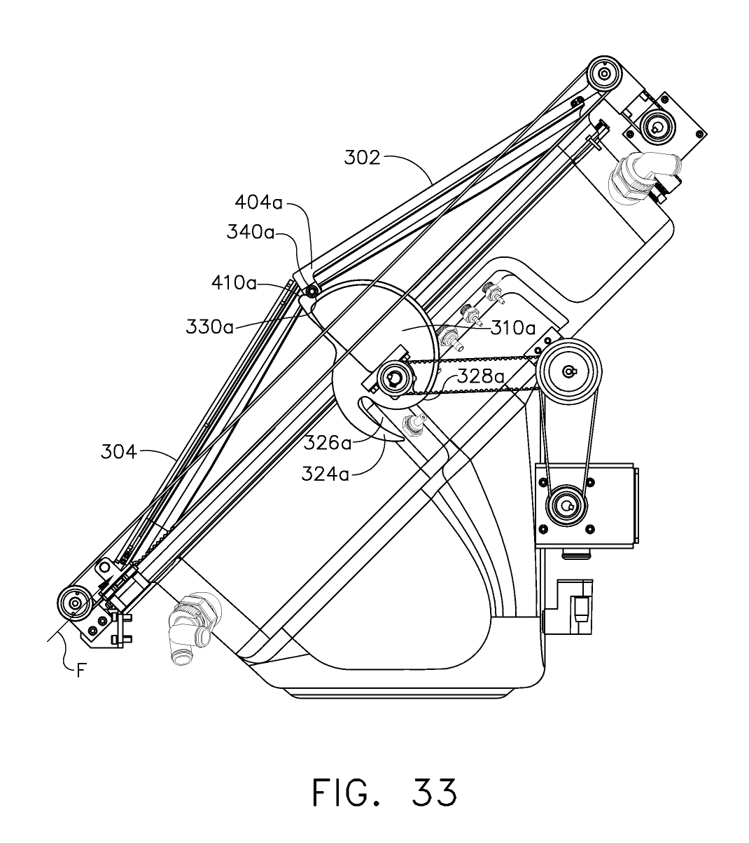

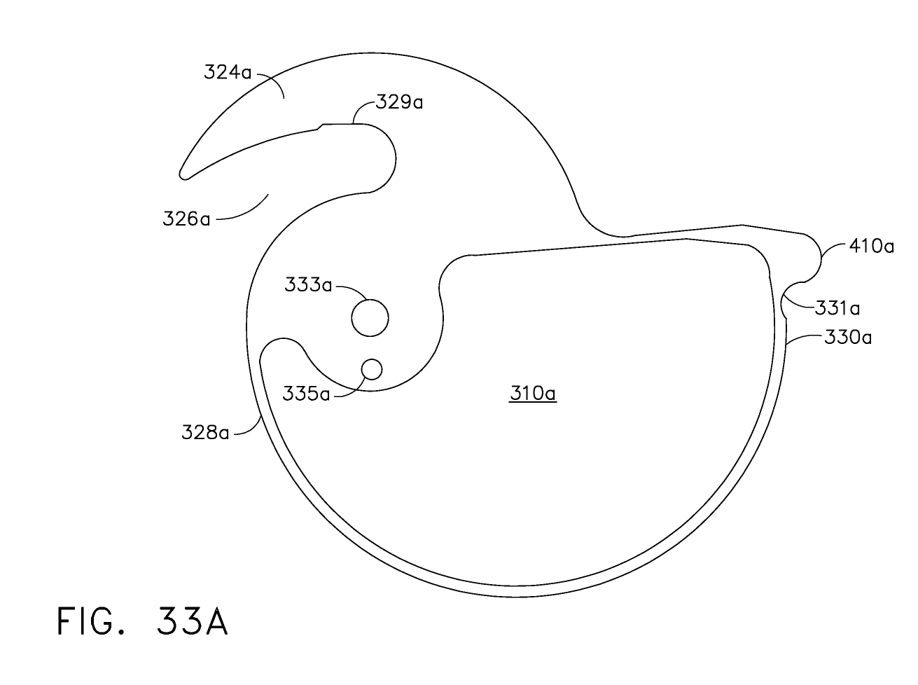

When the cams 310a, 310b are rotated out of their locked positions, the pins 340a, 340b may no longer be positioned within the locking channels 326a, 326b, respectively, thus permitting the lid 300 to be moved into an open position, as discussed above. In various embodiments, referring now to FIGS. 32 and 33, the cams 310a, 310b can be configured to move the lid 300 into an at least partially-open position. In at least one such embodiment, the cams 310a, 310b can each comprise an eccentric lobe including an outer perimeter which can be configured to engage the pins 340a, 340b, respectively, and drive the pins 340a, 340b upwardly, i.e., away from the basin frame 60. With regard to the eccentric lobe and outer perimeter of the cam 310a, the cam 310a can comprise a smaller-radius portion 328a and a larger-radius portion 330a. In at least one such embodiment, the pin 340a can be configured to rest against the outer perimeter of the cam 310a such that the pin 340a follows the contour of the outer perimeter of the cam 310a. In various circumstances, the weight of the lid 300, for example, can bias the pin 340a against the outer perimeter of the cam 310a. Referring again to FIG. 32, it can be seen that, when the pin 340a is positioned against the smaller-radius portion 328a of the cam 310a, the lid 300 may still lie in a closed, but unlocked, position against the frame 60. As the cam 310a is rotated from its position illustrated in FIG. 32, the larger-radius portion 330a may rotate into contact with the pin 340a. At such point, referring to FIG. 33, the cam 310a may lift the pin 340a and a portion of the lid 300, away from the frame 60. In various embodiments, the outer perimeter of the cam 310a can comprise a continuous surface which increases in radius with respect to an axis of rotation of the cam 310a between the smaller-radius portion 328a and the larger-radius portion 330a.

With regard to the eccentric lobe and outer perimeter of the cam 310b, the cam 310b can comprise a smaller-radius portion 328b and a larger-radius portion 330b. In at least one such embodiment, the pin 340b can be configured to rest against the outer perimeter of the cam 310b such that the pin 340b follows the contour of the outer perimeter of the cam 310b. In various circumstances, the weight of the lid 300, for example, can bias the pin 340b against the outer perimeter of the cam 310b. Referring again to FIG. 32, it can be seen that, when the pin 340b is positioned against the smaller-radius portion 328b of the cam 310b, the lid 300 may still lie in a closed, but unlocked, position against the frame 60. As the cam 310b is rotated from its position illustrated in FIG. 32, the larger-radius portion 330b may rotate into contact with the pin 340b. At such point, referring to FIG. 33, the cam 310b may lift the pin 340b and a portion of the lid 300, away from the frame 60. In various embodiments, the outer perimeter of the cam 310b can comprise a continuous surface which increases in radius with respect to an axis of rotation of the cam 310b between the smaller-radius portion 328b and the larger-radius portion 330b. In various embodiments, the eccentric lobes and outer perimeters of the cams 310a and 310b can be identical, or at least substantially identical, to one another wherein the cams 310a and 310b can be moved synchronously. In various embodiments, the cams 310a, 310b can each comprise a stop, such as stops 410a, 410b, for example, which can be configured to contact the pins 340a, 340b, respectively, and define the ends of the outer drive perimeters of the cams 310a, 310b.

In view of the above, the cams 310a and 310b can be configured to apply a lifting force to an intermediate portion of the lid 300. Stated another way, the lifting force is being applied to the lid 300 at a location positioned intermediate the top and bottom ends of the lid 300. In various embodiments, the instrument reprocessor 1 can comprise an actuator, which can be actuated by an operator of the instrument reprocessor 1, which can be configured to operate the motor 312 and rotate the cams 310a, 310. In at least one embodiment, the instrument reprocessor 1 can comprise a computer, or a controller, which can be instructed to at least partially open the lid. Such an instruction may be provided by actuating a switch, button, pedal, lever, and/or a computer icon on a touch screen (not shown), for example. Once the lid 300 has been at least partially opened, the lid 300 can be moved to its fully-opened position, as described above. When the lid 300 is moved between its partially-opened position and its fully-open position, the pins 340a and 340b can be lifted away from and may no longer contact the cams 310a and 310b. To close the lid 300, a manual closing force, or a closing force generated by motor 350, for example, can be utilized to pull the lower lid panel 304 downwardly into its closed position. More specifically, further to the above, the motor 350 can be operated to drive the belt and pulley systems discussed above in an opposite direction to thereby pull the connector portions 370a and 370b downwardly to position the lower lid panel 374 in its closed position. As the lower lid panel 304 is pulled into its closed position, the upper lid panel 302 can be pulled into its closed position via forces transmitted thereto via the hinge pins 340a, 340b connecting the lower lid panel 304 and the upper lid panel 302. In such a position, the pins 340a, 340b, may be in contact with the cams 310a, 310b once again. In order to lock the lid 300 in its closed position, the cams 310a and 310b can be rotated in an opposite direction such that the pins 340a and 340b can re-enter the lock channels 326a and 326b, respectively, and be driven into their closed position by the cams 310a, 310b.

FIG. 33a shows cam 310a removed from the bi-fold door 300. The cam 310a includes aperture 333a to accommodate a shaft (not shown) on which the pulley 318 is mounted. The cam 310a also may include a second aperture 335, which may engage a peg (not shown) or other feature on the pulley 318 to ensure that the cam 310a and the pulley 318 rotate in unison, as described above. Cam 310a also optionally includes a detent 329a arranged in the locking finger 324a in the locking channel 326a and a detent 331a arranged in the larger-radius portion 330a of the cam surface. The detent 329a is configured to engage the pin 340a when the pin 340a is positioned in the locking channel 326a. Similarly, the detent 331a is configured to engage the pin 340a when the pin 340a is positioned at an end of the larger-radius portion 330a of the cam 310a near stop 410a. The detents 329a and 331a can each provide equilibrium locations on the cam 310a, wherein, when positioned in a detent 329a or 331a, the pin 340a and the cam 310a may be inhibited from relative movement therebetween. The detent 329a in the locking channel 326a maintains the pin 340a in the locked position. Likewise, the detent 331a maintains the pin 340a in the partially open position. In various circumstances, a higher power output from motor 312 may be required to move the cam 310a relative to the pin 340a from the detents 329a and 331a than is required to move the cam 310a relative to the pin 340a at other portions of the cam 310a surface, such as, for example, moving the cam 310a relative to the pin 340a in a region of the cam 310a surface between the smaller-radius portion 328a and the larger radius portion 330a. Cam 310b may include corresponding detent features.

While rotatable cams configured to open, close, and/or lock the lid 300 have been discussed herein in detail, other actuators for opening, closing, and/or locking the lid 300 may be utilized. In various embodiments, an instrument reprocessor 1 can comprise one or more linear actuators which can be configured to bias the lid 300 into an open position. In at least such embodiment, a first linear actuator could be configured to apply a biasing force to the pin 340a while a second linear actuator could be configured to apply a biasing force to the pin 340b. In at least one such embodiment, the first and second linear actuators could be actuated simultaneously.

Various embodiments disclosed and described in this specification are directed, in part, to instrument reprocessors comprising a basin. The basin may comprise a bottom surface, a rim, and a sidewall connecting the bottom surface and the rim. The rim of the basin may be located in an inclined plane forming an acute angle with respect to the horizontal plane. At least one lateral nozzle may be located on the sidewall of the basin and disposed in a plane substantially parallel to the inclined plane. The lateral nozzle may be configured to discharge a stream into the basin in a direction substantially parallel to the inclined plane. Various embodiments disclosed and described in this specification are also directed, in part, to a method for reprocessing an instrument, such as, for example, an endoscope. The method may comprise positioning an instrument in a basin in an instrument reprocessor, such as, for example, an instrument reprocessor as described in this specification.

As used in this specification, the term “horizontal plane” refers to any plane parallel to the base of an instrument reprocessor, as described in this specification. As used in this specification, the term “acute angle” refers to an angle greater than 0.0 degrees (0.0 radians) and less than 90.0 degrees (π/2 radians) with respect to a reference plane such as, for example, the horizontal plane. An acute angle may range from 0.0 degrees to 90.0 degrees, exclusive, or any sub-range subsumed therein, such as, for example, 5.0° to 85.0°, 10.0° to 80.0°, 15.0° to 75.0°, 20.0° to 70.0°, 25.0° to 65.0°, 30.0° to 60.0°, 35.0° to 55.0°, 40.0° to 50.0°, and any sub-range comprising a minimum value and a maximum value selected from any of the above-described values.

As used in this specification, the term “inclined plane” refers to a plane forming an acute angle with respect to the horizontal plane. As used in this specification, the term “substantially,” when used to describe a plane or a direction as being parallel or perpendicular to a reference plane such as, for example, a horizontal plane or an inclined plane, means±5.0 degrees (±π/36 radians) from a parallel or perpendicular orientation. As used in this specification, the term “stream” refers to a fluid or fluid-carried substance, including, for example, liquids, gases, solutions, dispersions, suspensions, slurries, mists, vapors, and the like. As used in this specification, the term “disposed in a/the plane,” when used to describe a nozzle, refers to the orientation of the nozzle with respect to the specified plane so that a stream discharged from the nozzle has at least an initial trajectory parallel to the specified plane. It is understood, however, that a nozzle disposed in a specified plane is not necessarily located in any specific position, provided that a stream discharged from the nozzle has at least an initial trajectory parallel to the specified plane. Accordingly, the specific positioning of a nozzle disposed in a specified plane and configured to discharge a stream in a direction substantially parallel to the plane will be determined without limitation by the specific construction of the nozzle.

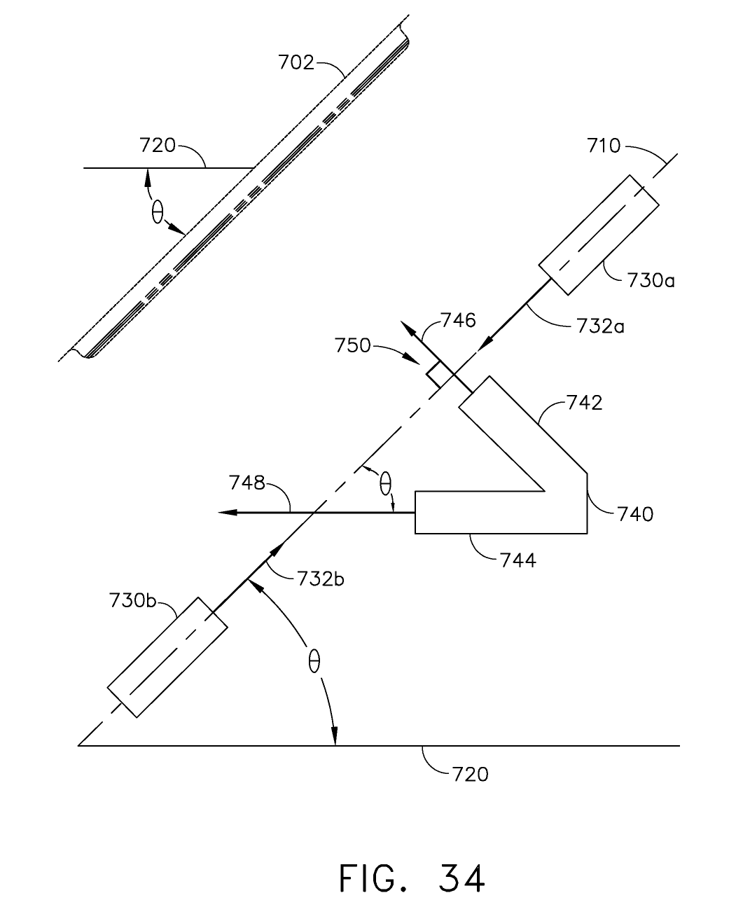

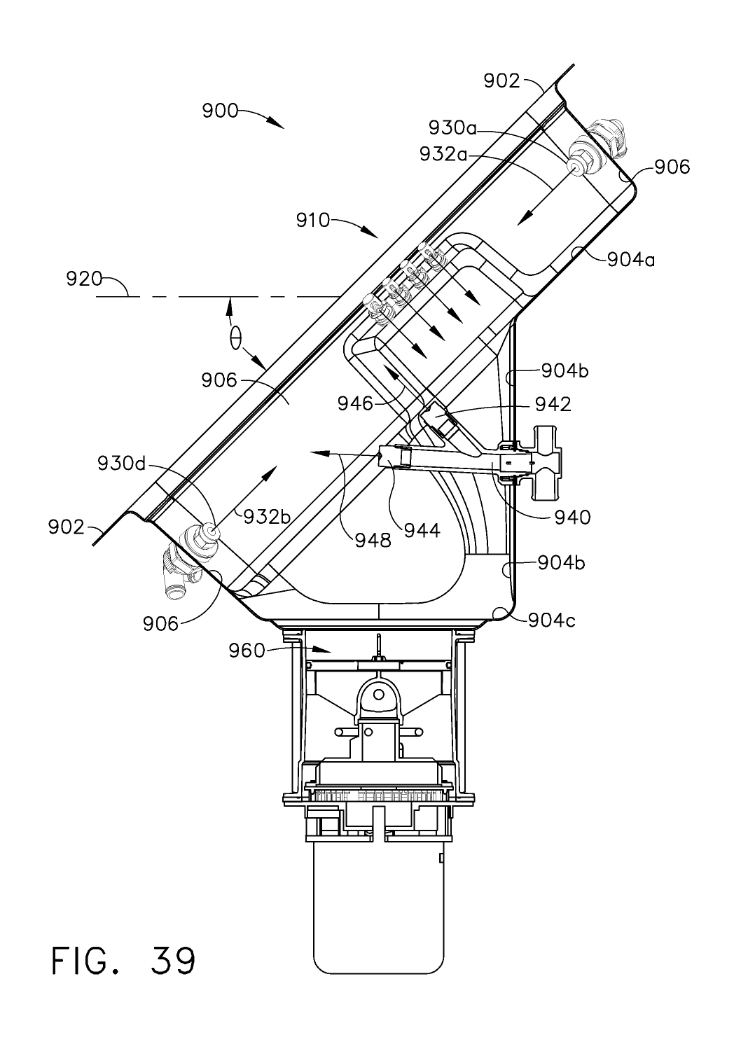

FIG. 34 is a schematic diagram illustrating the relative orientation of various nozzles with respect to an inclined plane. The system illustrated in FIG. 34 may comprise an instrument reprocessor as described in this specification, for example. The inclined plane 710 forms an acute angle θ with respect to the horizontal plane 720. Lateral nozzles 730a and 730b are disposed in the inclined plane 710. The inclined plane 710 may be substantially parallel to an inclined plane in which the rim 702 of a basin (not shown) is located. The lateral nozzles 730a and 730b may be located on the sidewall of a basin (refer to FIG. 39, for example). As indicated by arrows 732a and 732b, the lateral nozzles 730a and 730b, respectively, are configured to discharge streams in directions that are substantially parallel to the inclined plane 710.

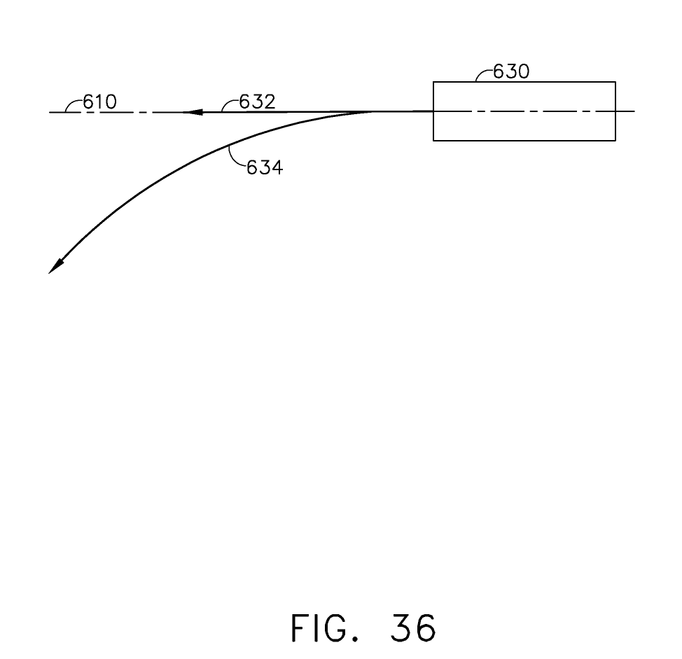

It is understood that a stream discharged from a nozzle will have a non-linear trajectory because of the influence of gravity on the material comprising the stream, for example. Accordingly, it is understood that the term “configured to discharge a stream in a direction,” as used in this specification to describe a nozzle, refers to the initial trajectory vector of the discharged stream, which is established by the location and disposition of the specified nozzle. Thus, as described in this specification, a nozzle disposed in a specified plane will discharge a stream in a direction that is substantially parallel to the specified plane and, therefore, the initial trajectory vector of the discharged stream will be substantially parallel to the specified plane notwithstanding that the downstream trajectory of the stream will deviate from the specified plane due to the influence of gravity, for example. This is illustrated in FIG. 36, which provides a schematic diagram showing a nozzle 630 disposed in a plane 610. As indicated by arrow 632, the nozzle 630 is configured to discharge a stream in a direction that is substantially parallel to the plane 610, i.e., having an initial trajectory vector that is substantially parallel to the plane 610 and a downstream trajectory indicated by arrow 634, the downstream trajectory deviating from the plane 610 due to the influence of gravity, for example.

Referring again to FIG. 34, a multi-outlet nozzle 740 comprises an orthogonal outlet 742 and an oblique outlet 744. It is understood that the multi-outlet nozzle 740 could comprise additional outlets disposed in any orientation. It is also understood that the system illustrated in FIG. 34 could comprise two separate nozzles, i.e., an orthogonal nozzle and a separate oblique nozzle. It is also understood that the system illustrated in FIG. 34 could comprise one or more additional multi-outlet nozzles 740 and/or one or more additional separate orthogonal nozzles and/or oblique nozzles. The multi-outlet nozzle 740 may be located on the bottom surface or a sidewall of a basin (refer to FIG. 39, for example). For clarity, the descriptions and illustrations provided in this specification disclose embodiments comprising a multi-outlet nozzle; however, a person having ordinary skill in the art reading this specification will appreciate that various alternative embodiments within the scope of the description may comprise separate orthogonal and oblique nozzles instead of or in addition to the described and illustrated multi-outlet nozzle.

The orthogonal outlet 742 is disposed in a plane substantially perpendicular to the inclined plane 710. As indicated by arrow 746, the orthogonal outlet 742 is configured to discharge a stream in a direction that is substantially perpendicular to the inclined plane 710 as indicated at 750.

The oblique outlet 744 is disposed in a plane forming an acute angle θ′ with respect to the inclined plane 710. As indicated by arrow 748, the oblique outlet 744 is configured to discharge a stream in a direction that forms an acute angle θ′ with respect to the inclined plane 710. As shown in FIG. 34, the oblique outlet 744 is disposed in a plane that is also substantially parallel to the horizontal plane 720 and, therefore, the acute angles θ and θ′ are substantially equal (i.e., to within ±5.0 degrees). It is understood, however, that the oblique outlet 744 may be disposed in a plane that is not substantially parallel to the horizontal plane 720, in which embodiments, the acute angles θ and θ′ would not be substantially equal.

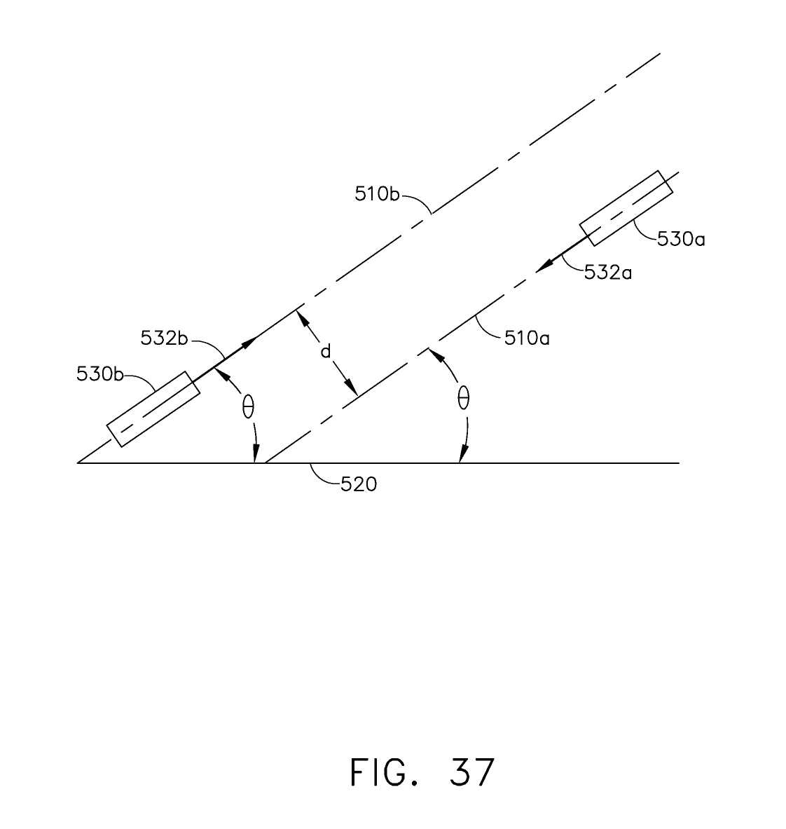

The system illustrated in FIG. 34 comprises two lateral nozzles 730a and 730b; however, it is understood that the system could comprise one, two, or more lateral nozzles disposed in the inclined plane 710. The system illustrated in FIG. 34 shows the lateral nozzles 730a and 730b in a co-planar orientation with respect to the inclined plane 710; however, it is understood that the lateral nozzles 730a and 730b may be disposed in separate inclined planes that each form an acute angle, which may be the same angle or different angles, with respect to the horizontal plane 720. For example, two or more lateral nozzles may be disposed in separate inclined planes, each inclined plane forming substantially the same acute angle with respect to the horizontal plane. In such embodiments, the lateral nozzles are disposed in substantially parallel inclined planes that are off-set from each other by a distance along a direction perpendicular to the inclined planes. This is illustrated in FIG. 37, which provides a schematic diagram showing nozzles 530a and 530b disposed in inclined planes 510a and 510b, respectively.

As indicated by arrow 532a, the nozzle 530a is configured to discharge a stream in a direction that is substantially parallel to the inclined plane 510a. As indicated by arrow 532b, the nozzle 530b is configured to discharge a stream in a direction that is substantially parallel to the inclined plane 510b. The inclined planes 510a and 510b both form substantially the same acute angle θ with respect to the horizontal plane 520. The inclined planes 510a and 510b are off-set from each other by a distance (d) along a direction perpendicular to the inclined planes.

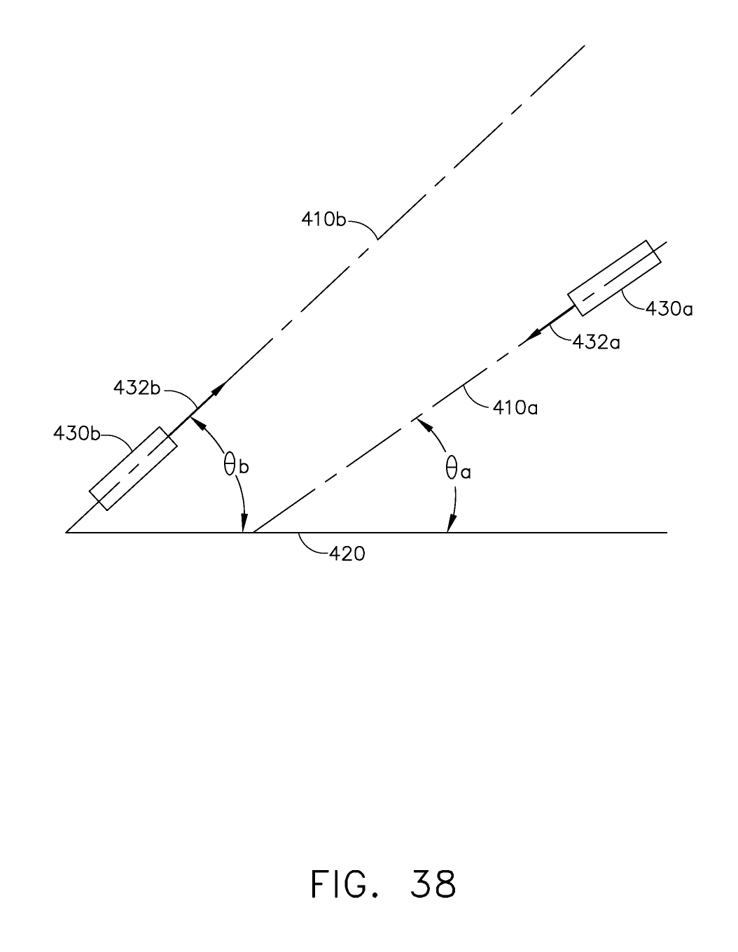

Two or more lateral nozzles may be disposed in separate inclined planes that each form different acute angles with respect to the horizontal plane. This is illustrated in FIG. 38, which provides a schematic diagram showing nozzles 430a and 430b disposed in inclined planes 410a and 410b, respectively. As indicated by arrow 432a, the nozzle 430a is configured to discharge a stream in a direction that is substantially parallel to the inclined plane 410a. As indicated by arrow 432b, the nozzle 430b is configured to discharge a stream in a direction that is substantially parallel to the inclined plane 410b. The inclined planes 410a and 410b form different acute angles θₐ and θ_{b}, respectively, with respect to the horizontal plane 420.

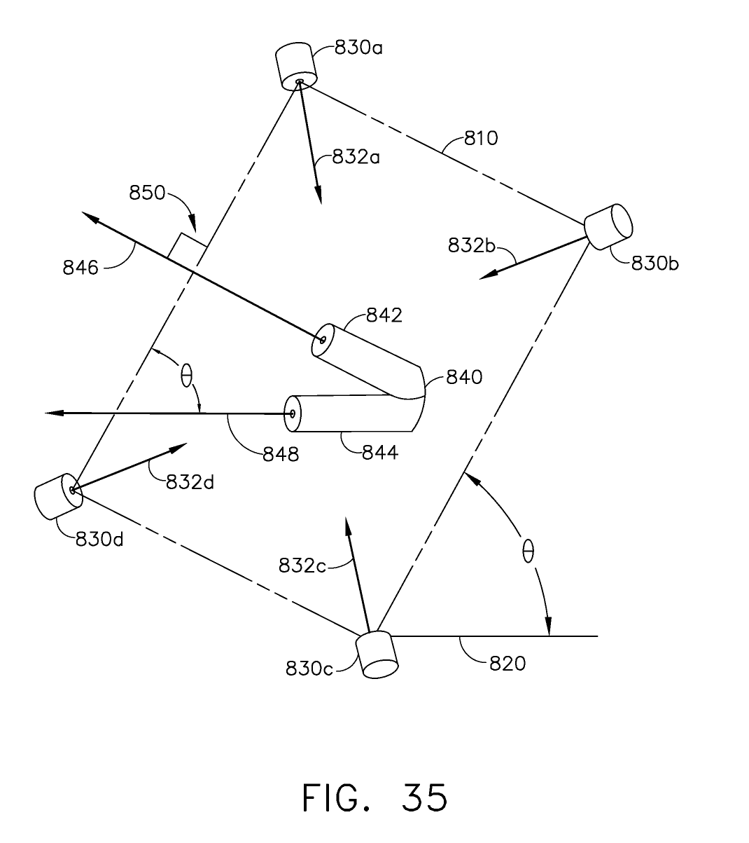

FIG. 35 is a schematic diagram illustrating the relative orientation of various nozzles with respect to an inclined plane. The system illustrated in FIG. 35 may be an instrument reprocessor as described in this specification, for example. The inclined plane 810 forms an acute angle θ with respect to the horizontal plane 820. Lateral nozzles 830a, 830b, 830c, and 830d are disposed in the inclined plane 810. The inclined plane 810 may be substantially parallel to an inclined plane in which the rim of a basin is located (refer to FIG. 39, for example). The lateral nozzles 830a, 830b, 830c, and 830d may be located on the sidewall of a basin (refer to FIG. 39, for example). As indicated by arrows 832a, 832b, 832c, and 832d, the lateral nozzles 830a, 830b, 830c, and 830d, respectively, are configured to discharge streams in directions that are substantially parallel to the inclined plane 810.

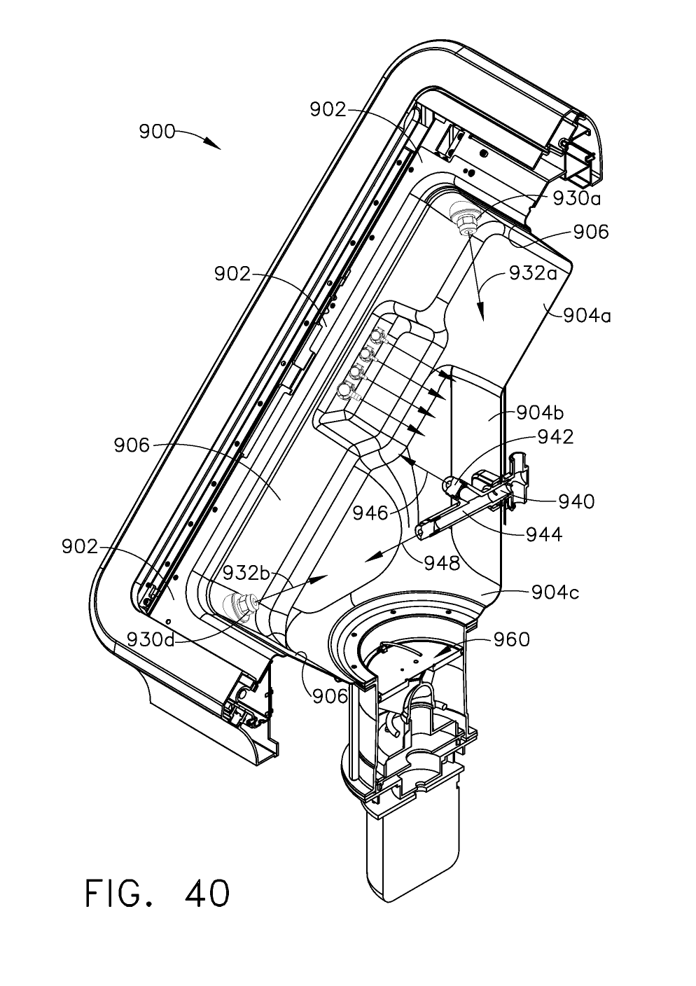

A multi-outlet nozzle 840 comprises an orthogonal outlet 842 and an oblique outlet 844. It is understood that the multi-outlet nozzle 840 could comprise additional outlets disposed in any orientation. It is also understood that the system illustrated in FIG. 35 could comprise two separate nozzles, i.e., an orthogonal nozzle and a separate oblique nozzle. It is also understood that the system illustrated in FIG. 35 could comprise one or more additional multi-outlet nozzles 840 and/or one or more additional separate orthogonal nozzles and/or oblique nozzles. For clarity, the descriptions and illustrations provided in this specification disclose embodiments comprising a multi-outlet nozzle; however, a person having ordinary skill in the art reading this specification will appreciate that various alternative embodiments within the scope of the description may comprise separate orthogonal and oblique nozzles instead of or in addition to the described and illustrated multi-outlet nozzle. The multi-outlet nozzle 840 may be located on the bottom surface of a basin (refer to FIG. 40, for example).

The orthogonal outlet 842 is disposed in a plane substantially perpendicular to the inclined plane 810. As indicated by arrow 846, the orthogonal outlet 842 is configured to discharge a stream in a direction that is substantially perpendicular to the inclined plane 810 as indicated at 850.

The oblique outlet 844 is disposed in a plane forming an acute angle with respect to the inclined plane 810. As indicated by arrow 848, the oblique outlet 844 is configured to discharge a stream in a direction that forms an acute angle θ′ with respect to the inclined plane 810. As shown in FIG. 35, the oblique outlet 844 is disposed in a plane that is also substantially parallel to the horizontal plane 820 and, therefore, the acute angles θ and θ′ are substantially equal (i.e., to within ±5.0 degrees). It is understood, however, that the oblique outlet 844 may be disposed in a plane that is not substantially parallel to the horizontal plane 820, in which embodiments, the acute angles θ and θ′ would not be substantially equal.

The system illustrated in FIG. 35 comprises four lateral nozzles 830a, 830b, 830c, and 830d; however, it is understood that the system could comprise one, two, three, four, or more lateral nozzles disposed in the inclined plane 810. The system illustrated in FIG. 35 shows the lateral nozzles 830a, 830b, 830c, and 830d in a co-planar orientation with respect to the inclined plane 810; however, it is understood that the lateral nozzles 830a, 830b, 830c, and 830d, or any sub-combinations thereof, may be disposed in separate inclined planes that each form an acute angle, which may be the same angle or different angles, with respect to the horizontal plane 820. See, for example, FIGS. 37 and 38, described above.

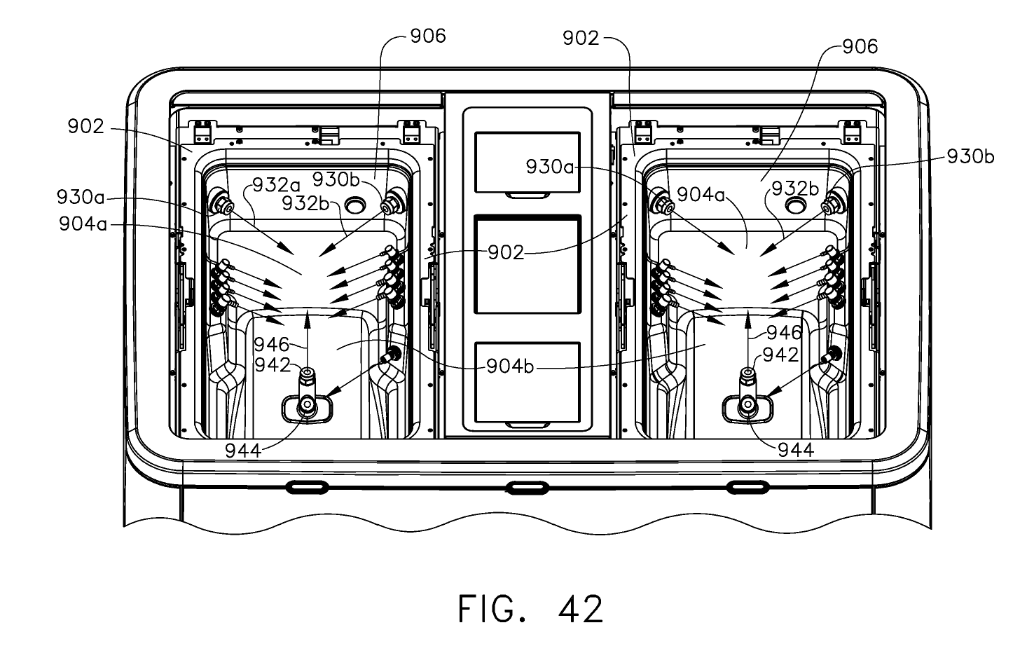

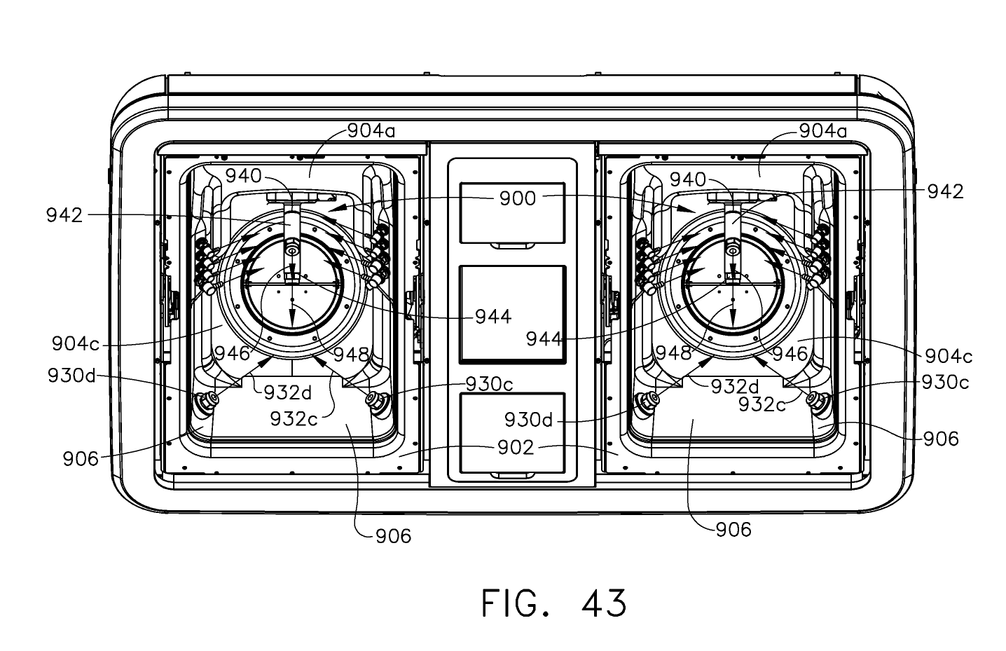

FIGS. 39 through 43 show various views of the basin component of an instrument reprocessor as described in this specification. The basin shown in FIGS. 39 through 43 may be substantially the same as the basin described above and shown in connection with FIGS. 7 through 10.

As shown in FIGS. 39 through 43, a non-limiting embodiment of an instrument reprocessor comprises a basin 900. The basin 900 comprises a rim 902 and a bottom surface 904. The bottom surface 904 of the basin 900 comprises a plurality of bottom surface segments or portions 904a, 904b, and 904c. The basin 900 comprises sidewalls 906. The sidewalls 906 connect the bottom surface 904 and the rim 902. The rim 902 is located in an inclined plane 910. The inclined plane 910 forms an acute angle θ with respect to the horizontal plane 920.

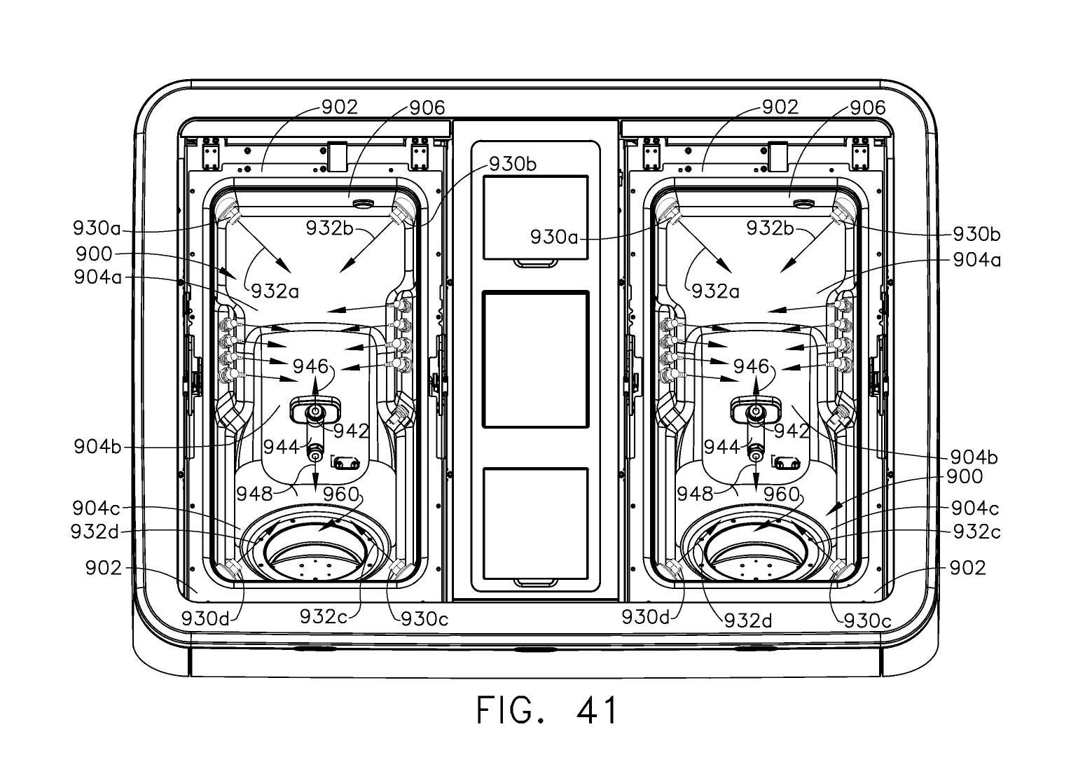

An instrument reprocessor also comprises lateral nozzles 930a, 930b, 930c, and 930d. The lateral nozzles 930a, 930b, 930c, and 930d are located on the sidewall 906 of the basin 900. The lateral nozzles 930a, 930b, 930c, and 930d are disposed in a plane substantially parallel to the inclined plane 910. As indicated by arrows 932a, 932b, 932c, and 932d, the lateral nozzles 930a, 930b, 930c, and 930d, respectively, are configured to discharge streams in directions that are substantially parallel to the inclined plane 910. As shown in FIG. 41, the sidewall 906 of the basin 900 is generally rectangular-shaped and the sidewall 906 comprises four sides and four corners. The lateral nozzles 930a, 930b, 930c, and 930d are respectively located at the four corners of the sidewall 906, disposed in a plane generally parallel to the inclined plane 910, and configured to discharge streams into the basin 900 in directions that are generally parallel to the inclined plane 910. Thus, the lateral nozzles 930a, 930b, 930c, and 930d are disposed in a co-planar orientation in which the coincident plane is generally parallel to the inclined plane 910. Likewise, the lateral nozzles 930a, 930b, 930c, and 930d are configured to discharge streams into the basin 900 in directions that are co-planar and parallel to the inclined plane 910.

The bottom surface 904 of the basin 900 comprises a plurality of bottom surface segments 904a, 904b, and 904c. The bottom surface segments 904a, 904b, and 904c form different angles with respect to the horizontal plane 920. The bottom surface segment 904a is inclined at an acute angle with respect to the horizontal plane 920 and is substantially parallel to the inclined plane 910 that includes the rim 902 of the basin 900. The bottom surface segment 904b is substantially perpendicular to the horizontal plane 920. The bottom surface segment 904c is substantially parallel to the horizontal plane. The bottom surface segment 904c comprises a drain 960 positioned through the bottom surface segment 904c.

The bottom surface segments 904a, 904b, and 904c are shown and described as planar-shaped portions of the bottom surface 904, which each form a different angle with respect to the horizontal plane. It is understood that the bottom surface of a basin is not limited to this configuration and may comprise, for example, one, two, three, or more planar surface segments or portions forming different angles with respect to the horizontal plane and that comprise the bottom surface of a basin. Alternatively, or in addition, the bottom surface of a basin of an instrument reprocessor as described in this specification may comprise a curved or contoured shape or segments/portions comprising a curved or contoured shape. For example, the bottom surface of a basin may comprise a convex shape, a concave shape, or a combination of convex and concave shapes that form a complex surface contour. Likewise, the bottom surface of a basin may comprise a combination of planar-shaped, concave-shaped, and/or convex-shaped surface segments/portions that form a complex surface contour.

An instrument reprocessor also comprises a multi-outlet nozzle 940. The multi-outlet nozzle is located on the bottom surface segment 904b. The multi-outlet nozzle 940 comprises two outlets configured to discharge a stream into the basin 900. The multi-outlet nozzle 940 comprises an orthogonal outlet 942 and an oblique outlet 944. It is understood that the multi-outlet nozzle 940 could comprise additional outlets disposed in any orientation. It is also understood that instrument reprocessor could comprise two separate nozzles, i.e., an orthogonal nozzle and a separate oblique nozzle instead or in addition to the multi-outlet nozzle 940. It is also understood that an instrument reprocessor could comprise one or more additional multi-outlet nozzles 940 and/or one or more additional separate orthogonal nozzles and/or oblique nozzles. For clarity, the descriptions and illustrations provided in this specification disclose embodiments comprising a multi-outlet nozzle; however, a person having ordinary skill in the art reading this specification will appreciate that various alternative embodiments within the scope of the description may comprise separate orthogonal and oblique nozzles instead of or in addition to the described and illustrated multi-outlet nozzle.

The multi-outlet nozzle 940 is shown and described as being located on the bottom surface segment 904b. It is understood that the nozzle configuration of a basin of an instrument reprocessor is not limited to this configuration. For example, one or more multi-outlet nozzles may be located on any portion or segment of the bottom surface of the basin. Alternatively, or in addition, one or more multi-outlet nozzles may be located on any portion or segment of the sidewall of the basin, provided that the nozzles discharge streams in a direction substantially perpendicular to the inclined plane containing the rim of the basin and in a direction that forms an acute angle with respect to the inclined plane.

The orthogonal outlet 942 is disposed in a plane substantially perpendicular to the inclined plane 910. As indicated by arrow 946, the orthogonal outlet 942 is configured to discharge a stream in a direction that is substantially perpendicular to the inclined plane 910.

The oblique outlet 944 is disposed in a plane forming an acute angle with respect to the inclined plane 910. As indicated by arrow 948, the oblique outlet 944 is configured to discharge a stream in a direction that forms an acute angle with respect to the inclined plane 910. The oblique outlet 944 is disposed in a plane that is also substantially parallel to the horizontal plane 920 and, therefore, the acute angle of the inclined plane 910 and the acute angle formed between the inclined plane and the oblique outlet 944 are substantially equal (i.e., to within ±5.0 degrees). It is understood, however, that the oblique outlet 944 may be disposed in a plane that is not substantially parallel to the horizontal plane 920, in which embodiments, the respective acute angles would not be substantially equal.

The basin and nozzle assembly illustrated in FIGS. 39 through 43 comprises four lateral nozzles 930a, 930b, 930c, and 930d; however, it is understood that the assembly could comprise one, two, three, four, or more lateral nozzles. The basin and nozzle assembly illustrated in FIGS. 39 through 43 shows the lateral nozzles 930a, 930b, 930c, and 930d in a co-planar orientation with respect to the inclined plane 910; however, it is understood that the lateral nozzles 930a, 930b, 930c, and 930d, or any sub-combinations thereof, may be disposed in separate inclined planes that each form an acute angle, which may be the same angle or different angles, with respect to the horizontal plane 920. See, for example, FIGS. 37 and 38, described above.

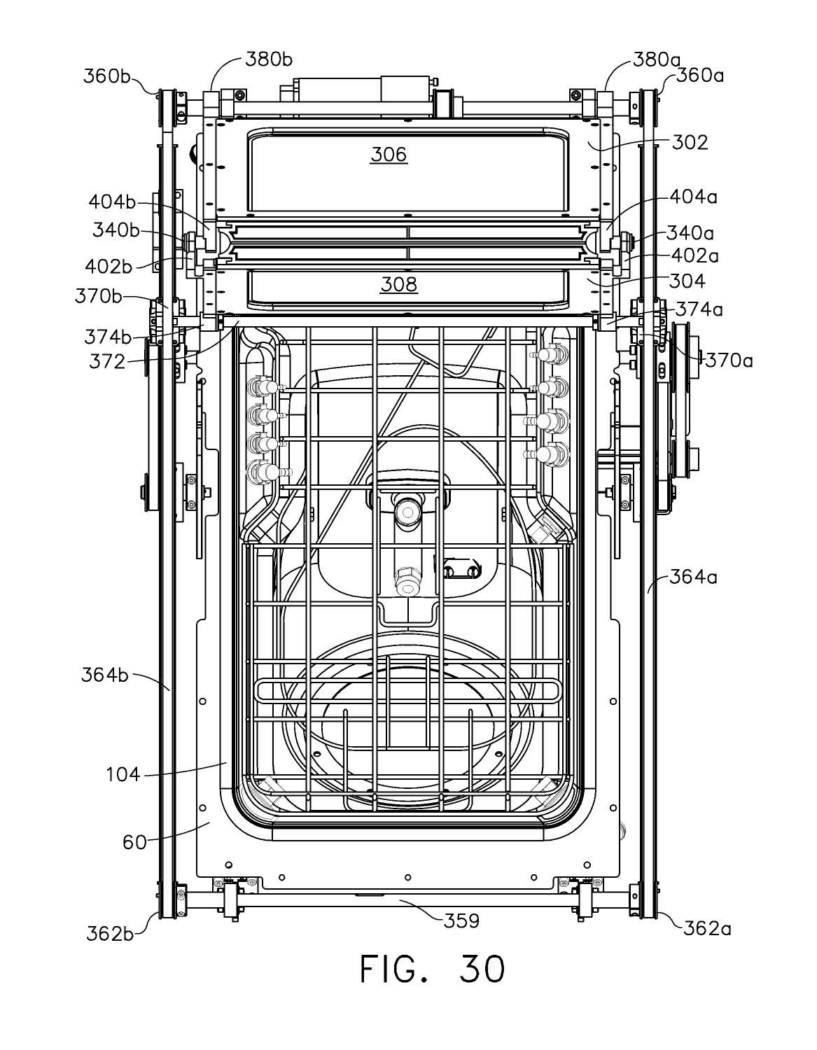

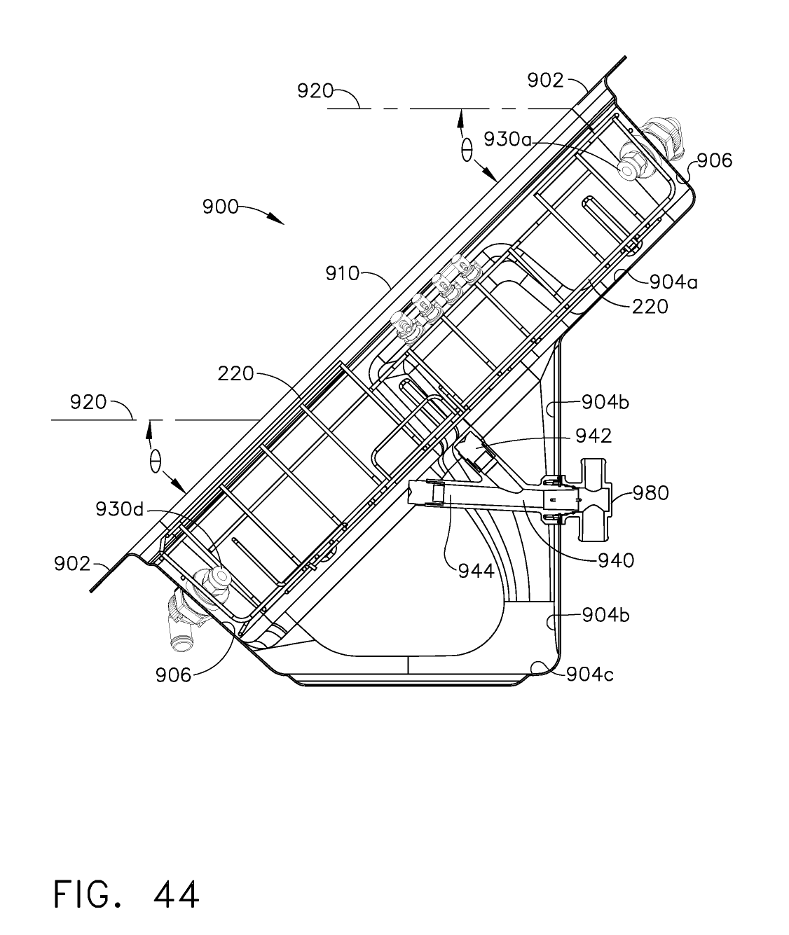

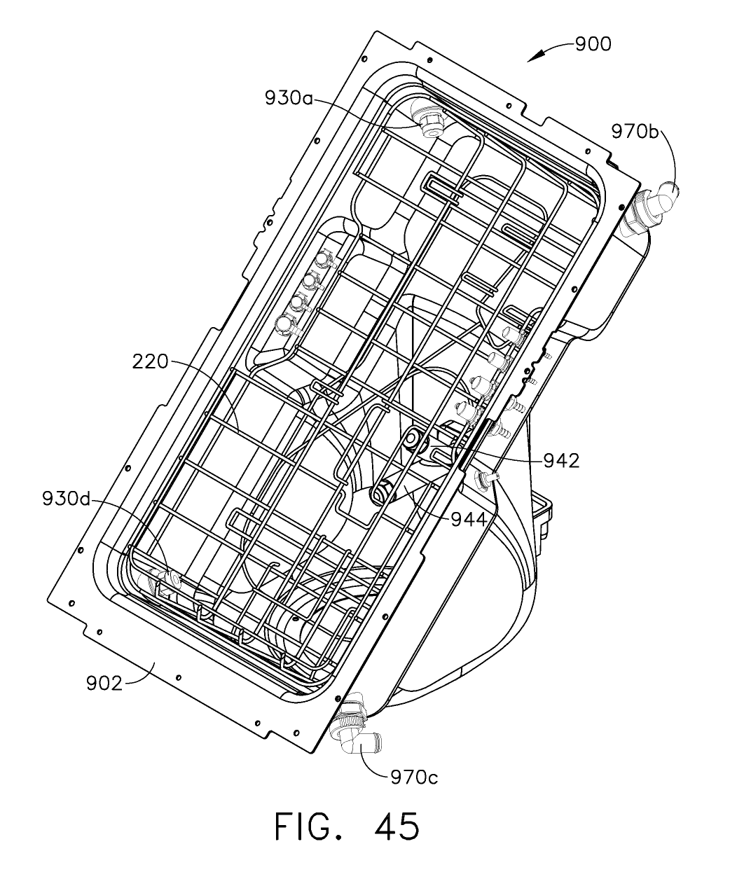

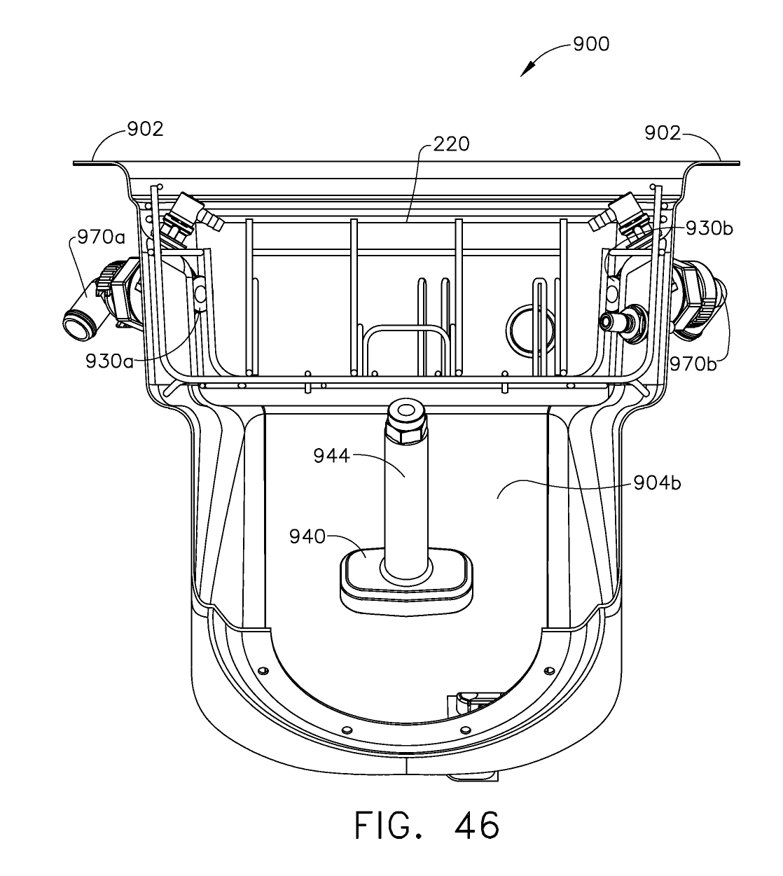

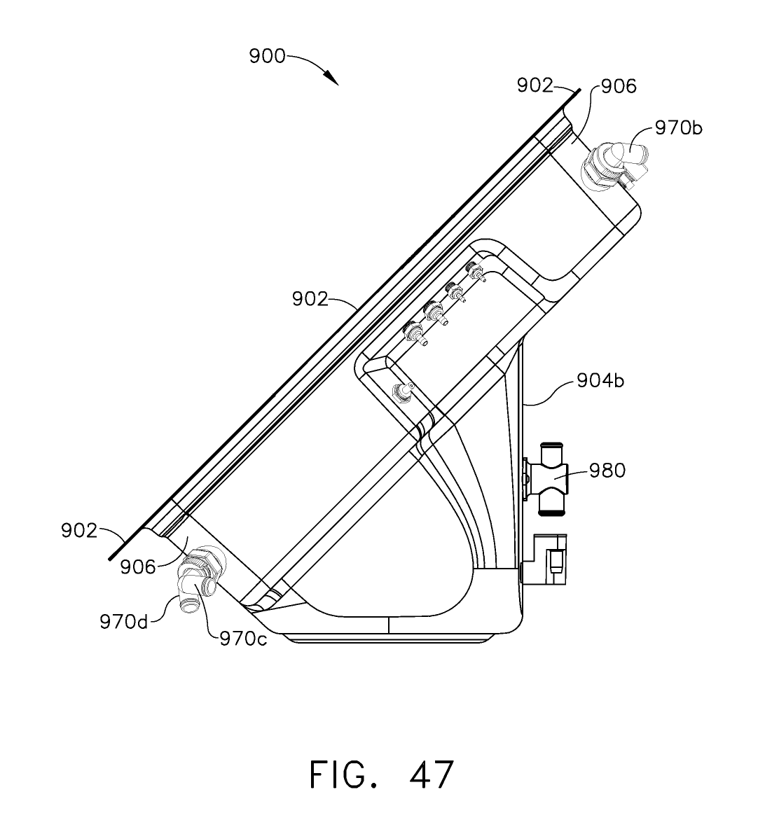

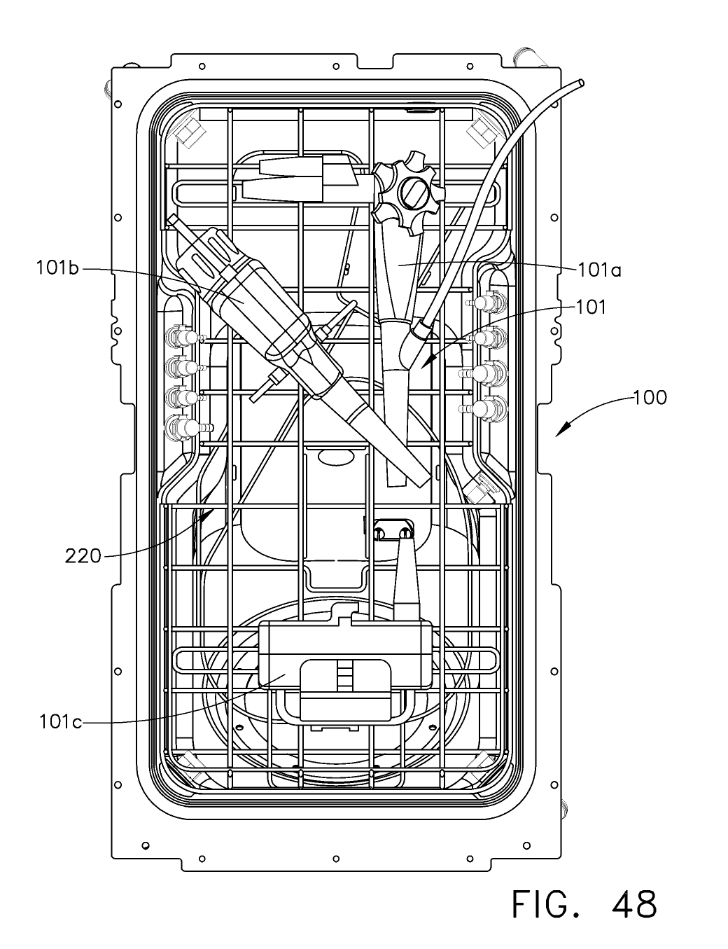

FIGS. 44 through 47 show various views of the basin component of an instrument reprocessor supporting a removable carrier as described in this specification. The basin shown in FIGS. 44 through 47 may be substantially the same as the basin described above and shown in connection with FIGS. 30 through 43. The carrier shown in FIGS. 44 through 47 may be substantially the same as the carrier described above and shown in connection with FIGS. 11 through 16.

Referring to FIGS. 44 through 47, the lateral nozzles 930a, 930b, 930c, and 930d are connected to lateral ports 970a, 970b, 970c, and 970d, respectively. The lateral nozzles 930a, 930b, 930c, and 930d connect to the lateral ports 970a, 970b, 970c, and 970d through respective openings in the sidewall 906 of the basin 900. The multi-outlet nozzle 940 is connected to a multi-inlet port 980. The multi-outlet nozzle 940 connects to the multi-inlet port 980 through an opening in the bottom surface segment 904b of the basin 900.

The lateral nozzles, the multi-inlet nozzles, and/or the separate orthogonal and oblique nozzles comprising the basin and nozzle assembly of an instrument reprocessor, as described in this specification, are connected through corresponding ports to fluid lines that supply the streams discharged by the nozzles, for example, liquids, gases, solutions, dispersions, suspensions, slurries, mists, vapors, and the like. The fluid supply lines connected to the nozzles through corresponding ports are also connected to a fluid supply system that controls the discharge of the streams from the nozzles into the basin. For example, the nozzles comprising the basin and nozzle assembly of an instrument reprocessor, as described in this specification, may be connected to sources of water, detergents, disinfectant solutions, air, and/or the like. In this manner, the nozzles are configured to discharge water, detergents, disinfectant solutions, air, and/or the like, during different cycles of an instrument reprocessing operation. In various non-limited embodiments, the nozzles comprising the basin and nozzle assembly of an instrument reprocessor, as described in this specification, may be connected to a delivery system, dosing system, and/or an independent monitoring system as described in the contemporaneously-filed, co-owned U.S. patent application entitled INSTRUMENT REPROCESSOR AND INSTRUMENT REPROCESSING METHODS, Attorney Docket No. 110514, the entire disclosure of which is incorporated by reference into this specification.

The basin 900 is configured to support a removable carrier 220 positioned in the basin 900. When positioned in the basin 900, the removable carrier 220 is disposed in a plane substantially parallel to the inclined plane 910, as shown in FIGS. 44 through 46. The carrier 220 is configured to position an instrument, such as, for example, an endoscope, in the basin 900 so that the instrument (not shown) is disposed in a plane substantially parallel to the inclined plane 910. In this manner, an instrument contained in the carrier 220 is disposed in a plane substantially parallel to the inclined plane 910 when the carrier 220 (containing the instrument) is positioned in the basin 900 and the carrier 220 is disposed in a plane substantially parallel to the inclined plane 910.

The lateral nozzles 930a, 930b, 930c, and 930d, and the multi-outlet nozzle 940 (and/or separate orthogonal and oblique nozzles, not shown), are configured to discharge streams into the basin 900 that impinge upon an instrument (not shown), such as, for example, an endoscope, when the instrument is contained in the removable carrier 220 and positioned in the basin 900 in a plane substantially parallel to the inclined plane 910 so that the instrument (e.g., endoscope) forms an acute angle with respect to the horizontal plane. The impinging streams discharged from the nozzles 930a, 930b, 930c, 930d, and 940 may comprise water, detergent, disinfectant solution, air, and/or the like.

For example, the nozzles 930a, 930b, 930c, 930d, and 940 may discharge water as a stream that impinges upon an instrument (e.g., an endoscope, not shown) contained in the carrier 220 and positioned in the basin 900 to rinse blood and/or other body wastes from the outer surfaces of the instrument. The nozzles 930a, 930b, 930c, 930d, and 940 may discharge a liquid detergent as a stream that impinges upon an instrument (e.g., an endoscope, not shown) contained in the carrier 220 and positioned in the basin 900 to clean the outer surfaces of the instrument of residual blood and/or other body wastes. The nozzles 930a, 930b, 930c, 930d, and 940 may discharge a disinfectant as a stream that impinges upon an instrument (e.g., an endoscope, not shown) contained in the carrier 220 and positioned in the basin 900 to disinfect the outer surfaces of the instrument. The nozzles 930a, 930b, 930c, 930d, and 940 may discharge water as a stream that impinges upon an instrument (e.g., an endoscope, not shown) contained in the carrier 220 and positioned in the basin 900 to rinse residual liquid detergent and/or disinfectant solution. The nozzles 930a, 930b, 930c, 930d, and 940 may discharge air or another gas as a stream that impinges upon an instrument (e.g., an endoscope, not shown) contained in the carrier 220 and positioned in the basin 900 to dry the instrument after a reprocessing cycle in which the nozzles discharged water, liquid detergent, and/or disinfectant solution.

The streams discharged by the nozzles and configured to impinge upon an instrument (e.g., an endoscope) contained in a carrier and positioned in a basin in an instrument reprocessor, as described in this specification, may be controlled, collectively or independently, to have predetermined discharge pressures, discharge flow rates, discharge velocities, discharge volumes, and/or discharge temperatures to effectively clean and/or disinfect the instrument without submerging the instrument in a liquid. For example, the streams discharged by the nozzles 930a, 930b, 930c, 930d, and 940 into the basin 900 may be configured to impinge upon an instrument (e.g., an endoscope, not shown) contained in the carrier 220 and positioned in the basin 900 in an instrument reprocessor with collectively or independently controlled discharge pressures, discharge flow rates, discharge velocities, discharge volumes, and/or discharge temperatures to effectively clean and/or disinfect the instrument, wherein the instrument is not submerged in a liquid in the basin 900. In this manner, the discharged streams impinge upon the instrument, which is suspended in the basin 900 by the carrier 220 in an inclined orientation as described above, and drain from the basin 900 through the drain 960 positioned through the bottom surface segment 904c, which prevents that instrument from being submerged in liquid.

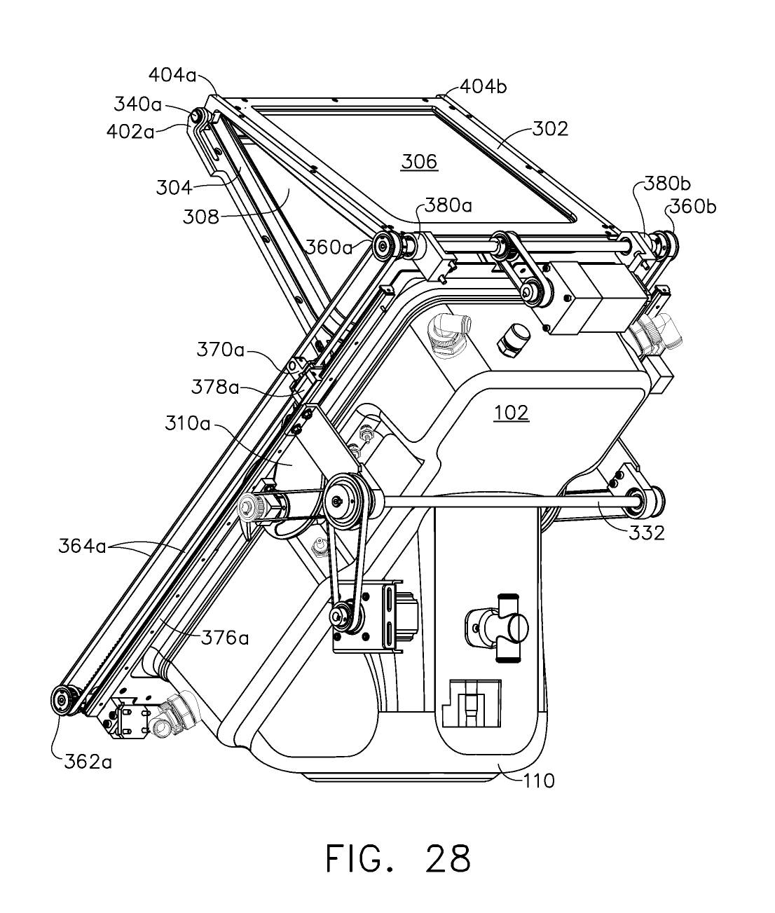

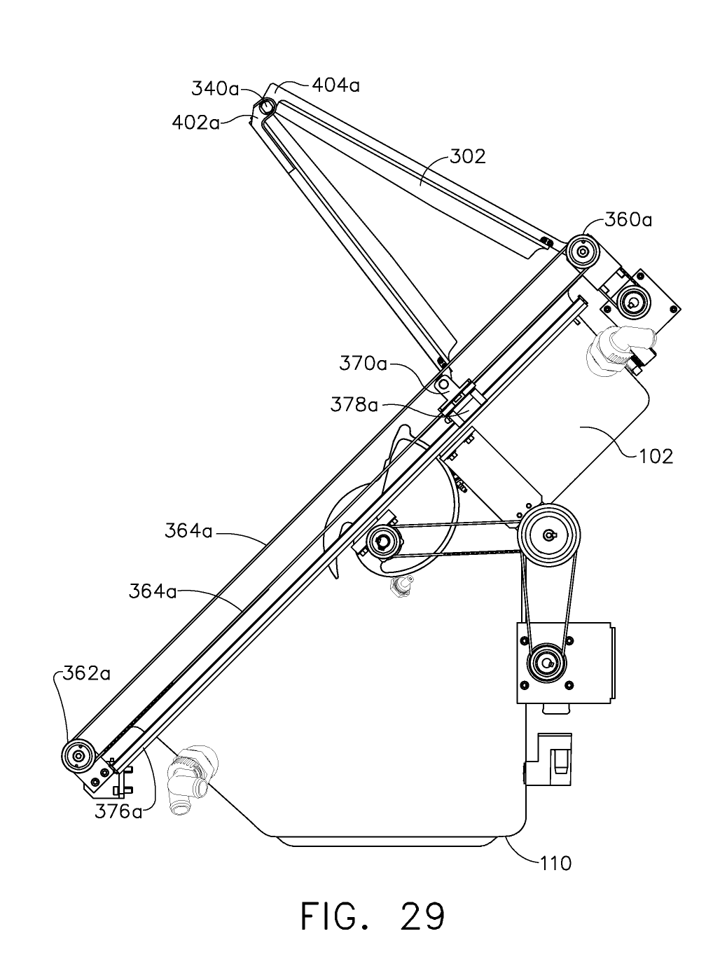

An instrument reprocessor comprising a basin and nozzle assembly as described in this specification may also comprise a lid assembly configured to close and seal the basin inside the instrument reprocessor. In various non-limiting embodiments, a lid may cover the basin in a closed configuration, thereby forming a closed basin chamber. In the closed configuration, the lid may be disposed in an inclined plane that is substantially parallel to the inclined plane in which the rim of the basin is located. For example, a bi-fold lid 300 as described in FIGS. 17 through 33, when covering the basin 900 in a closed configuration, may be disposed in an inclined plane that is substantially parallel to the inclined plane 910 in which the rim 902 of the basin 900 is located.

Various embodiments disclosed and described in this specification are directed, in part, to a method for reprocessing an instrument, such as, for example, an endoscope. The method may comprise positioning an instrument in a basin in an instrument reprocessor. The instrument reprocessor may comprise an instrument reprocessor as described in this specification. For example, the basin may comprise a rim located in an inclined plane forming an acute angle with respect to a horizontal plane.

The instrument may be positioned in the basin in a plane substantially parallel to the inclined plane and at the acute angle with respect to the horizontal plane. The basin may be covered, for example, with bi-fold lid as described in this specification, thereby forming a closed basin chamber. One or more lateral streams may be discharged into the basin in directions substantially parallel to the inclined plane. The one or more lateral streams may impinge onto the outer surfaces of the instrument to clean and/or disinfect the outer surfaces of the instrument. The impinging streams may drain from the closed basin chamber so that the instrument is not submerged in liquid in the basin chamber during reprocessing.

In various non-limiting embodiments, a method for reprocessing an instrument may further comprise discharging an orthogonal stream into the basin in a direction substantially perpendicular to the inclined plane. The orthogonal stream may impinge onto the outer surfaces of the instrument to clean and/or disinfect the outer surfaces of the instrument. Alternatively, or in addition, a method for reprocessing an instrument may further comprise discharging an oblique stream into the basin in a direction that forms an acute angle with respect to the inclined plane. For example, in various non-limiting embodiments, the oblique stream may be discharged in a direction substantially parallel to the horizontal plane. The oblique stream may impinge onto outer surfaces of the instrument to clean and/or disinfect the outer surfaces of the instrument. In various non-limiting embodiments, one or more nozzles may discharge a stream that impinges onto one or more surfaces of a closed basin chamber. For example, one or more nozzles may impinge onto an inner surface of a closed lid, which may disinfect and/or clean the inner surface of the lid.

Positioning the instrument in the basin in a plane substantially parallel to the inclined plane and at the acute angle with respect to the horizontal plane may comprise positioning a carrier containing the instrument in the basin. The carrier may be positioned in the basin in a plane substantially parallel to the inclined plane and at the acute angle with respect to the horizontal plane. For example, a carrier 220 may be positioned in a basin 900 as described in this specification in connection with FIGS. 44 through 47.

Various embodiments disclosed and described in this specification are directed, in part, to instrument reprocessors comprising a basin. The basin may comprise a bottom surface, a rim, and a sidewall connecting the bottom surface and the rim. The rim of the basin may be located in an inclined plane forming an acute angle with respect to the horizontal plane. At least one lateral nozzle may be located on the sidewall of the basin and disposed in a plane substantially parallel to the inclined plane. The lateral nozzle may be configured to discharge a stream into the basin in a direction substantially parallel to the inclined plane.

An instrument reprocessor may comprise a plurality of lateral nozzles located on the sidewall of the basin. The lateral nozzles located on the sidewall of the basin may be disposed in a plane substantially parallel to the inclined plane. The lateral nozzles located on the sidewall of the basin may be configured to discharge a stream into the basin in a direction substantially parallel to the inclined plane. For example, an instrument reprocessor may comprise at least four lateral nozzles located on the sidewall of the basin, wherein the lateral nozzles are disposed in a plane parallel to the inclined plane, and wherein the lateral nozzles are configured to discharge a stream into the basin in a direction parallel to the inclined plane. In various non-limiting embodiments, the sidewall of the basin may be generally rectangular-shaped and the sidewall may comprise four sides and four corners. The at least four lateral nozzles may be respectively located at the four corners of the sidewall, disposed in a plane generally parallel to the inclined plane, and configured to discharge a stream into the basin in a direction generally parallel to the inclined plane.

The bottom surface of the basin may comprise a plurality of bottom surface segments or portions. The plurality of bottom surface segments or portions may form different angles with respect to the horizontal plane. For example, at least one segment or portion of the bottom surface may be inclined at an acute angle with respect to the horizontal plane. In various non-limiting embodiments, a segment or portion of the bottom surface may be inclined at an acute angle with respect to the horizontal plane so that an inclined plane including the segment or portion is substantially parallel to the inclined plane that includes the rim of the basin. At least one segment or portion of the bottom surface may be substantially perpendicular to the horizontal plane. At least one segment or portion of the bottom surface may be substantially parallel to the horizontal plane. In various non-limiting embodiments, the bottom surface of the basin may comprise at least one segment or portion inclined at an acute angle with respect to the horizontal plane, at least one segment or portion substantially perpendicular to the horizontal plane, and/or at least one segment or portion substantially parallel to the horizontal plane.

An instrument reprocessor may comprise an orthogonal nozzle. The orthogonal nozzle may be located on the bottom surface or the sidewall of the basin. The orthogonal nozzle may be disposed in a plane substantially perpendicular to the inclined plane. The orthogonal nozzle may be configured to discharge a stream into the basin in a direction substantially perpendicular to the inclined plane.

An instrument reprocessor may comprise an oblique nozzle. The oblique nozzle may be located on the bottom surface or the sidewall of the basin. The oblique nozzle may be disposed in a plane forming an acute angle with the inclined plane. The oblique nozzle may be configured to discharge a stream into the basin in a direction forming an acute angle with the inclined plane. In various non-limiting embodiments, an oblique nozzle may be disposed in a plane substantially parallel to the horizontal plane and may be configured to discharge a stream into the basin in a direction substantially parallel to the horizontal plane.

In various non-limiting embodiments, an instrument reprocessor may comprise an orthogonal nozzle and an oblique nozzle. The orthogonal nozzle and the oblique nozzle may be located on the bottom surface and/or the sidewall of the basin. The orthogonal nozzle may be disposed in a plane substantially perpendicular to the inclined plane and may be configured to discharge a stream into the basin in a direction substantially perpendicular to the inclined plane. The oblique nozzle may be disposed in a plane forming an acute angle with the inclined plane, such as, for example, the horizontal plane, and may be configured to discharge a stream into the basin in a direction substantially parallel to the horizontal plane.

In various non-limiting embodiments, an instrument reprocessor may comprise a multi-outlet nozzle. The multi-outlet nozzle may be located on the bottom surface or the sidewall of the basin. The multi-outlet nozzle may comprise two or more outlets configured to discharge a stream into the basin. The two or more outlets may comprise an orthogonal outlet and an oblique outlet. The orthogonal outlet may be disposed in a plane substantially perpendicular to the inclined plane and may be configured to discharge a stream into the basin in a direction substantially perpendicular to the inclined plane. The oblique outlet may be disposed in a horizontal plane and configured to discharge a stream into the basin in a direction substantially parallel to the horizontal plane.

An instrument reprocessor may comprise a basin configured to support a removable carrier positioned in the basin. When positioned in the basin, the removable carrier may be disposed in a plane substantially parallel to the inclined plane and at an acute angle with respect to the horizontal plane.

An instrument reprocessor may comprise-a removable carrier. The basin of the instrument reprocessor may be configured to support the carrier in the basin. When positioned in the basin, the removable carrier may be disposed in a plane substantially parallel to the inclined plane. The carrier may be configured to position an instrument, such as, for example, endoscope, in the basin so that the instrument is disposed in a plane substantially parallel to the inclined plane and at an acute angle with respect to the horizontal plane.

Any patent, publication, or other disclosure material, in whole or in part, that is said to be incorporated by reference herein is incorporated herein only to the extent that the incorporated materials do not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

While this invention has been described as having exemplary designs, the present invention may be further modified within the spirit and scope of the disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A lid assembly, comprising:
a frame comprising an opening, wherein the frame includes a frame hinge at a first end, and wherein the frame includes a guide along a first side;
a lid that covers the opening in a closed configuration, the lid comprising:
a first lid panel having first and second ends, wherein the first lid panel is coupled at its first end to the frame hinge, and wherein the first lid panel is pivotable relative to the frame about the frame hinge;
a second lid panel having first and second ends, wherein the first lid panel and the second lid panel lie in a plane when the lid is in the closed configuration;
a lid hinge, wherein the first lid panel is coupled to the lid hinge at its second end, wherein the second lid panel is coupled to the lid hinge at its first end, and wherein the first lid panel is pivotable relative to the second lid panel about the lid hinge;
a follower coupled to the second lid panel proximate to the second end, wherein the follower is movably engaged with the guide such that the follower follows the guide as the lid moves from the closed configuration to an open configuration; and
a displacer coupled to the frame at a location proximate to the lid hinge when the lid is in the closed configuration, wherein the displacer displaces the lid hinge away from the frame.

2. The lid assembly of claim 1, wherein the displacer comprises a cam coupled to an actuator that moves the cam between a first position and a second position, wherein in the first position the cam does not displace the lid hinge, and wherein in the second position the cam displaces the lid hinge.

3. The lid assembly of claim 1, wherein the actuator comprises one of an electric motor or a solenoid.

4. The lid assembly of claim 1, wherein the guide comprises a channel, and wherein the follower is movably engaged with the channel.

5. The lid assembly of claim 1, wherein the displacer further comprises a lock, wherein the lock includes a locked position and an unlocked position, wherein in the locked position the lock maintains the lid hinge proximate to the frame and the lid in the closed configuration, and wherein in the unlocked position of the lock the lid hinge is free to displace away from the frame.

6. The lid assembly of claim 5, wherein said lock comprises a slot configured to receive the lid hinge and to maintain the lid hinge relative to the frame when the lock is in the locked position.

7. The lid assembly of claim 6, further comprising a detent in the slot and configured to inhibit relative movement between the lock and the lid hinge.

8. An instrument reprocessor comprising:
a basin comprising a bottom surface, a rim, and a sidewall connecting the bottom surface and the rim, wherein the rim is located in an inclined plane forming an acute angle with respect to a horizontal plane; and
at least one lateral nozzle located on the sidewall and disposed in a plane substantially parallel to the inclined plane, the at least one lateral nozzle configured to discharge a stream into the basin in a direction substantially parallel to the inclined plane.

9. The instrument reprocessor of claim 8, wherein a portion of the bottom surface is inclined at an acute angle with respect to the horizontal plane and is substantially parallel to the inclined plane, a portion of the bottom surface is substantially perpendicular to the horizontal plane, and a portion of the bottom surface is substantially parallel to the horizontal plane.

10. The instrument reprocessor of claim 8, wherein the acute angle between the inclined plane and the horizontal plane is in the range of 40 degrees to 50 degrees.

11. The instrument reprocessor of claim 8, further comprising at least one of:
an orthogonal nozzle located on the bottom surface, the orthogonal nozzle disposed in a plane substantially perpendicular to the inclined plane and configured to discharge a stream into the basin in a direction substantially perpendicular to the inclined plane; and
an oblique nozzle located on the bottom surface, the oblique nozzle disposed in a plane substantially parallel to the horizontal plane and configured to discharge a stream into the basin in a direction substantially parallel to the horizontal plane.

12. The instrument reprocessor of claim 8, further comprising a multi-outlet nozzle located on the bottom surface, the multi-outlet nozzle comprising:
an orthogonal outlet disposed in a plane substantially perpendicular to the inclined plane and configured to discharge a stream into the basin in a direction substantially perpendicular to the inclined plane; and
an oblique outlet disposed in a plane substantially parallel to the horizontal plane and configured to discharge a stream into the basin in a direction substantially parallel to the horizontal plane.

13. The instrument reprocessor of claim 8, further comprising a lid that covers the basin in a closed configuration, wherein, in the closed configuration, the lid is disposed in an inclined plane that is substantially parallel to the inclined plane in which the rim is located.

14. The instrument reprocessor of claim 8, wherein the basin is configured to support a removable carrier positioned in the basin and disposed in a plane substantially parallel to the inclined plane.

15. The instrument reprocessor of claim 8, further comprising a removable carrier, wherein the basin is configured to support the removable carrier in the basin and disposed in a plane substantially parallel to the inclined plane, and wherein the removable carrier is configured to position an endoscope in the basin and disposed in a plane substantially parallel to the inclined plane so that the endoscope forms an acute angle with respect to the horizontal plane.

16. The instrument reprocessor of claim 15, further comprising an endoscope contained in the removable carrier and positioned in the basin in a plane substantially parallel to the inclined plane so that the endoscope forms an acute angle with respect to the horizontal plane.

17. A method for reprocessing an instrument comprising:
positioning an instrument in a basin in an instrument reprocessor, the basin comprising a rim located in an inclined plane forming an acute angle with respect to a horizontal plane, the instrument positioned in the basin in a plane substantially parallel to the inclined plane and at an acute angle with respect to the horizontal plane;
covering the basin, thereby forming a closed basin chamber;
discharging at least one lateral stream into the basin in a direction substantially parallel to the inclined plane; and
impinging the at least one lateral stream onto an outer surface of the instrument to clean and/or disinfect the outer surface of the instrument;
wherein the instrument is not submerged in liquid in the basin chamber.

18. The method of claim 17, further comprising:
discharging an orthogonal stream into the basin in a direction substantially perpendicular to the inclined plane, wherein the orthogonal stream impinges onto outer surfaces of the instrument to clean and/or disinfect the outer surfaces of the instrument; and/or
discharging an oblique stream into the basin in a direction substantially parallel to the horizontal plane, wherein the oblique stream impinges onto outer surfaces of the instrument to clean and/or disinfect the outer surfaces of the instrument.

19. The method of claim 17, wherein the acute angle between the inclined plane and the horizontal plane is in the range of 40 degrees to 50 degrees.

20. The method of claim 17, wherein positioning the instrument in the basin comprises positioning a carrier containing the instrument in the basin, the carrier positioned in the basin in a plane substantially parallel to the inclined plane and at an acute angle with respect to the horizontal plane.
